(19) United States
(12) Patent Application Publication
(10) Pub. No.: US 2013/0046557 A1
(43) Pub. Date: Feb. 21, 2013

(54) PERSON REPORTED OUTCOME REPORT GENERATION

(71) Applicants: Amer Jawad Mirza, Lake Oswego, OR (US); Mahmood Stephen Mirza, Bellevue, WA (US)

(72) Inventors: Amer Jawad Mirza, Lake Oswego, OR (US); Mahmood Stephen Mirza, Bellevue, WA (US)

(73) Assignee: Seattle Information Systems, Inc., Bellevue, WA (US)

(21) Appl. No.: 13/450,167

(22) Filed: Apr. 18, 2012

Related U.S. Application Data
(63) Continuation of application No. 12/506,893, filed on Jul. 21, 2009, now abandoned.
(60) Provisional application No. 61/135,607, filed on Jul. 21, 2008.

(51) Int. Cl. G06Q 50/24

(52) U.S. Cl. 705/3

(57) ABSTRACT

A method and programmable circuit generates a medical report on a single page from data reported by a person. In one possible configuration and by non-limiting example, a method and a programmable circuit generate a single page outcome report based on characteristics perceived by a person, such as a patient receiving care. In another possible embodiment, a method or programmable circuit generate a medical report in one language based on responses to a survey that is in another language.

### CROSS REFERENCE TO RELATED APPLICATIONS

This application is a continuation of U.S. patent application Ser. No. 12/506,893, filed Jul. 21, 2009 which claims the benefit of U.S. Provisional Patent Application Ser. No. 61/135,607, filed Jul. 21, 2008, the entire disclosures of which are hereby incorporated herein by reference in their entirety.

### BACKGROUND

When a medical caregiver conducts a consultation with a patient, it is frequently useful to the medical caregiver to know how the patient has perceived certain person characteristics over time. For example, the medical caregiver may find it useful to know whether the level of pain, or other characteristic a patient feels or perceives, has been changing over time. Knowing whether the patient perceives certain person characteristics to be improving, holding steady, or worsening over time may help the medical caregiver to know whether the patient's therapy is effective.

### SUMMARY

In general terms, this disclosure is directed to generating a medical report from data reported by a person. In one possible configuration and by non-limiting example, a method and a programmable circuit generate a single page outcome report based on characteristics perceived by a person, such as a patient receiving care. In another possible embodiment, a method or programmable circuit generate a medical report in one language based on responses to a survey that is in another language.

### BRIEF DESCRIPTION OF THE DRAWINGS

FIG. 1 is a schematic diagram illustrating an example system for generating a report from person reported information.

FIG. 2 illustrates an example survey page.

FIG. 3 illustrates an example graphical report.

FIG. 4 illustrates an example graph in a graphical report.

FIG. 5 is a schematic diagram illustrating an example link between a graphical indicator in a graph and survey responses corresponding to the graphical indicator.

FIG. 6 is a schematic flow diagram illustrating an example operation to generate and use a graphical report.

FIG. 7 illustrates an exemplary architecture of a computing device that can be used to implement aspects of the present disclosure.

FIG. 8 is a schematic logical block diagram illustrating an example system for generating a person outcome report.

FIG. 9 is a schematic logical block diagram illustrating another example system for generating a person outcome report.

FIG. 10 is a schematic logical block diagram illustrating yet another example system for generating a person outcome report.

FIG. 11 is a schematic logical block diagram illustrating an example client device.

FIG. 12 is a schematic logical block diagram illustrating an example server computing system.

FIG. 13 is a schematic flow diagram illustrating an example operation of the client device.

FIG. 14 is a schematic flow diagram illustrating an example operation of the server computing system.

FIG. 15 is a schematic diagram illustrating an example system for generating a graphical report from person reported data where questions are presented in one language and a graphical report is presented in another language.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

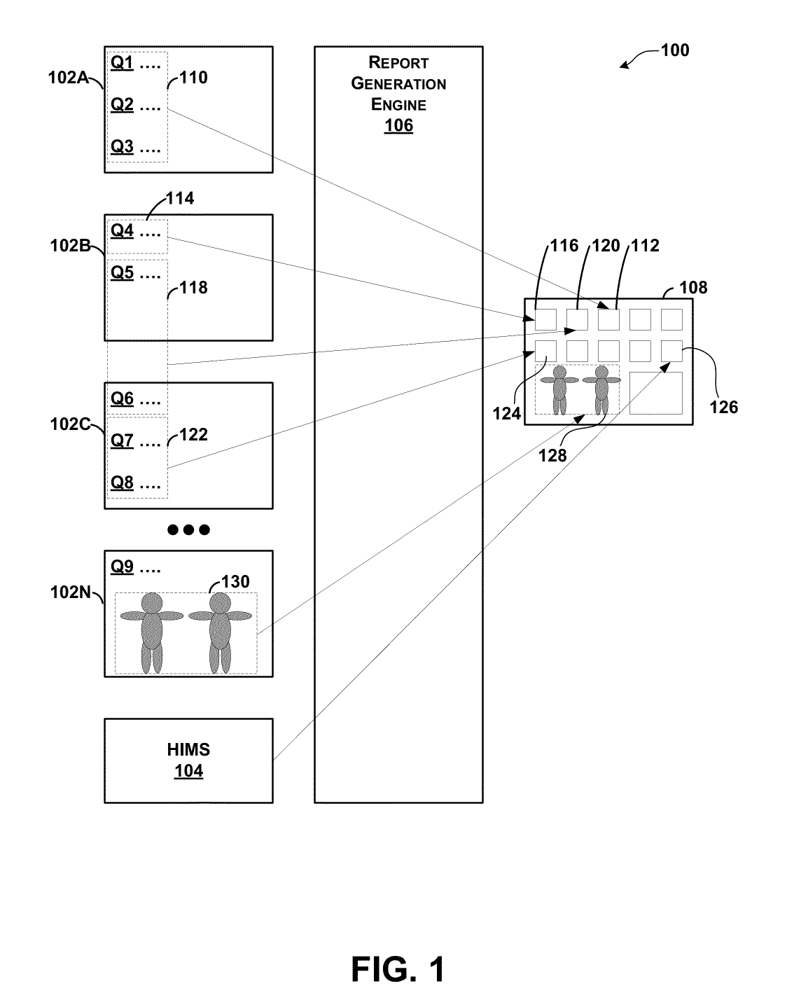

FIG. 1 is a schematic diagram illustrating an example system 100 for generating a report from person reported information. Although the term “graphical report” is used in this disclosure, it is to be understood that the system disclosed herein can be used to generate reports that include text, graphics, or a combination of text and graphics. Additionally, the term “person” can include a patient, a research subject, or any other person whose perceived person characteristics are being documented in responses to questions of a survey. A survey includes a set of one or more questions. A question includes any type of inquiry that requests some type of input from a person, whether the input is an answer or some other type of input from the person.

The system 100 includes survey pages 102A-102N (collectively, “survey pages 102”). In addition, the system 100 includes a hospital information management system (HIMS) 104, a report generation engine 106, and a graphical report 108.

Each of the survey pages 102 includes at least one question in a survey. In the example of FIG. 1, questions in the survey pages 102 are illustrated as the letter “Q” followed by a number. A client device, which is discussed in more detail herein, displays the survey pages 102 to a person. The person responds to some or all of the questions in the survey pages 102 by providing input to the client device. After the person has responded to at least some of the questions on one of the survey pages 102, the client device displays another one of the survey pages to the person. In some embodiments, the person is able to instruct the client device which ones of the survey pages 102 to display by providing appropriate input to the client device. For instance, the person may instruct the client device to show a next one of the survey pages 102 or a previous one of the survey pages 102. Although the example of FIG. 1 shows the questions in the survey displayed in a plurality of survey pages, it should be appreciated that in other embodiments, all of the questions in the surveys are displayed in a single page.

In different instances, the client device displays the survey pages 102 to different types of people. In one example, the client device presents the survey pages 102 to a patient receiving medical care. In another example, the client device presents the survey pages 102 to a person who is a research subject. In yet other examples, the client device presents the survey pages 102 to other types of people.

In different instances, the client device presents the survey pages 102 to a person at a variety of different physical locations. For instance, in one example embodiment, the client device is located at the home of the person responding to the questions in the survey pages 102. In another example embodiment, the client device is located at an office of a medical caregiver. Examples of caregivers include any type of healthcare provider who provides, prescribes, or recommends therapies, such as medical doctors, nurse practitioners, nurses, chiropractors, physiologists, trainers, and the like. In yet another example embodiment, the client device is located at a laboratory of a researcher. In other embodiments, the client device may be located at other physical locations.

A person may respond to questions in the survey pages 102 in a variety of different situations. For instance, in one example embodiment, a person responds to the questions in the survey pages 102 when the person is preparing for an encounter with a medical caregiver. The encounter may be a wide variety of different types of interaction between the person and the medical caregiver either in person or via a communication technology. For instance, the encounter may be an examination, a consultation, an intervention, a surgery, a physical therapy session, a training session, a psychological therapy session, an appointment, or another type of interaction between the person and the medical caregiver. In another example embodiment, a person responds to the questions in the survey pages 102 as part of a routine remote health monitoring program. In yet another example embodiment, a person responds to the questions in the survey pages 102 at times dictated by a research study.

The questions in the survey pages 102 belong to one or more surveys. In different instances, questions belonging to the surveys are designed to elicit one or more different types of information from a person responding to the surveys. In one example, the survey pages 102 include questions belonging to a first survey that is designed to elicit information about pain perceived by the person. Furthermore, in this example, the survey pages 102 also include questions belonging to a second survey that is designed to elicit information about the person's general health as perceived by the person. In another example, the survey pages 102 include questions belonging to a first survey that elicits demographic information about the person and the survey pages 102 include questions belonging to a second survey that elicits information about the person's dental issues as perceived by the person. Additionally, the survey can include questions custom to a caregiver or researcher, questions from surveys that are generally accepted by or generally available to caregivers and researchers in the healthcare and research industries, or a combination of these. Examples of surveys that are generally available include the SF36™ Health Survey, the SF-12 Health Survey, the SF-8™ Health Survey, and the SF-10™ Health Survey provided by QualityMetric, Inc. of Lincoln, R.I.

Different questions in the survey pages 102 allow the person to provide different types of responses. For instance, in one example, a question in one of the survey pages 102 allows the person to respond to the question by selecting one or more answers from multiple possible answers. In other words, in this example, the question is a multiple choice question. In another example, a question in one of the survey pages 102 allows the person to respond to the question by selecting true or false. In yet another example, a question in one of the survey pages 102 allows the person to respond to the question by selecting a value corresponding to a point or position on a scale (e.g., from 1 to 10). In yet another example, a question in one of the survey pages 102 allows the person to respond to the question by entering text into a textbox displayed by the client device. In yet another example, a question in one of the survey pages 102 allows the person to respond to the question by entering narrative text into a text entry area displayed by the client device. In yet another example, a question in one of the survey pages 102 allows the person to respond to the question by indicating on a graphical image of at least a portion of the human body where the person is perceiving a symptom to be occurring or to have occurred. In the example of FIG. 1, the survey page 102N includes a question “Q9” that allows the person to respond to the question by indicating on a graphical image of at least a portion of the human body where the person perceives a symptom to be occurring or to have occurred.

In different embodiments and as discussed in more detail herein, a person is able to provide input to the client device in different ways. For instance, in one example embodiment, a person is able to provide input to the client device via a touch screen. In another example embodiment, a person is able to provide input to the client device via a pointing device, such as a mouse, trackball, or stylus tool. In yet another example embodiment, a person is able to provide input to the client device via a keyed input device, such as a keyboard or a keypad. In other embodiments, a person is able to provide input to the client device in different ways. In yet another example embodiment, a person is able to provide input to the client device via a microphone that receives voice instructions.

After the person has provided to the client device a response to at least one question in the survey pages, the report generation engine 106 uses responses to questions in the survey pages to generate the graphical report 108. Furthermore, in the system 100 illustrated in the example of FIG. 1, the report generation engine 106 uses data accessible from the HIMS 104. The HIMS 104 provides access to hospital information. Example types of hospital information include medical records and other information about the person, billing information, medical research data, caregiver information, and other types of information used in a medical environment. In other embodiments, the report generation engine 106 uses data accessible through other data sources to generate the graphical report 108. For instance, in another example embodiment, the report generation engine 106 uses data accessible through a corporate database system.

As described in more detail herein, in different embodiments, the report generation engine 106 can be implemented by various computing devices and at various locations. Such computing devices include at least one programmable circuit. For instance, in one example embodiment, the report generation engine 106 is implemented by a server computing system at an office of a medical caregiver. In another example embodiment, the report generation engine 106 is located at a third-party location other than a caregiver facility. In yet another example embodiment, the report generation engine 106 is implemented by the client device at a home of the person.

To generate the graphical report 108, the report generation engine 106 uses the responses to the questions in the survey pages 102 to obtain a data item set. At least one of the data items in the data item set is based on responses by the person to one or more questions in the survey pages 102. For instance, a data item in the data item set may be based on one response by the person to one question in the survey pages 102 or may be based on a plurality of responses by the person to a plurality of questions in the survey pages 102. Each of the data item sets includes at least one data item.

Examples of data items include items of data indicative of person characteristics as perceived by a person. Examples of person characteristics include a mental or physical characteristic of a person. For instance, in one example, one or more of the data items are indicative of a level of neck pain perceived by a person. In another example, one or more of the data items are indicative of locations on the person's body where the person perceives a symptom to be occurring or to have occurred.

The report generation engine 106 stores a plurality of data item sets on a computer readable medium. Each of the data item sets corresponds to a separate time a single person responded to the questions in the survey pages 102. For instance, if a person responded to questions in the survey pages 102 on January 1 and responded to the same questions in the survey pages 102 on March 15, the report generation engine 106 stores a first data item set corresponding to the responses provided by the person on January 1 and a second data item set corresponding to the responses provided by the person on March 15.

In different embodiments, the report generation engine 106 stores the data item sets on different types of computer readable medium. For instance, in one example embodiment, the report generation engine 106 stores the data item sets at least partially in a random access memory (RAM). In another example embodiment, the report generation engine 106 stores the data items at least partially on a magnetic disk drive, tape drive, optical disc, holographic storage media, or one or more other types of data storage media. In different embodiments, the report generation engine 106 stores the data items at computer readable media located at different locations. For instance, the report generation engine 106 may store the data items at a computing device local to the person, at a computing device local to a medical caregiver, at a computing device remote from the person and the medical caregiver, or at another suitable location.

In one possible embodiment, the report generation engine 106 generates the graphical report 108 such that the graphical report 108 fits on a single page. For instance, in one example embodiment, the report generation engine 106 generates the graphical report 108 such that the graphical report 108 fits on a single sheet of A4 sized paper. In other example embodiments, the report generation engine 106 generates the graphical report 108 such that the graphical report 108 fits on a single sheet of paper having another size, such as letter size paper, legal size paper, ledger size paper, tabloid size paper, or another size of paper. Furthermore, in other example embodiments, the report generation engine 106 generates the graphical report 108 such that all or essentially all of the graphical report 108 is displayed by a display device in a way that is conceptually analogous to a single printed page. For instance, if a display device has a diagonal length of 15 inches, the report generation engine 106 may generate the graphical report 108 such that the graphical report 108 has a diagonal length of 15 inches.

An example of a graph that can be presented in the graphical report 108 includes at least a first graphical indicator and a second graphical indicator. The first graphical indicator corresponds to a first one of the data item sets stored by the report generation engine 106. The second graphical indicator corresponds to a second one of the data item sets stored by the report generation engine 106. At least one data item in the first one of the data item sets corresponds to the first graphical indicator and at least one data item in the second one of the data items second corresponds to the second graphical indicator. A data item corresponds to a graphical indicator when the report generation engine 106 uses the data item to determine a position of the graphical indicator on a graph.

Data items corresponding to the first graphical indicator and data items corresponding to the second graphical indicator correspond to a same perceived person characteristic as perceived by the person at different times. In one example, data items corresponding to the first graphical indicator correspond to back pain as perceived by the person on January 1 and data items corresponding to the second graphical indicator correspond to back pain as perceived by the person on March 15. In some example implementations, graphs are highlighted when significant magnitude changes have occurred in a patient characteristic.

The example of FIG. 1 illustrates relationships between questions in the survey pages 102 and graphs in the graphical report 108. In the example of FIG. 1, a group of questions 110 corresponds to a graph 112 in the graphical report. In other words, the report generation engine 106 generates a data item based on the responses provided by the person to questions in the group of questions 110 and displays a graphical indicator corresponding to the data item in the graph 112. In another example, a single question 114 corresponds to a graph 116 in the graphical report 108. In yet another example, a group of questions 118 corresponds to a graph 120 in the graphical report 108. Note that the group of questions 118 spans two of the survey pages 102. In general, groups of questions do not need to be on a single one of the survey pages 102, be on consecutive ones of survey pages 102, be consecutive within a survey or otherwise have any relationship to the order of the survey pages 102 or any relationship to other questions within the survey pages 102. In addition, a group of questions 122 corresponds to a graph 124 in the graphical report 108. In the example of FIG. 1, the graphical report 108 includes a graph 126 corresponding to data accessible through the HIMS 104. Furthermore, it should be appreciated that in some embodiments, a question in the survey pages 102 corresponds to a plurality of the Furthermore, as illustrated in the example of FIG. 1, the graphical report 108 includes a graphical image 128 of at least a portion of a human body. In the example of FIG. 1, the graphical report 108 includes a graphical image of an entire human body, front and back. In other example embodiments, the graphical report 108 includes a graphical image of only a body part, such as a hand, arm, leg, foot, and so on. A question 130 allows the person to respond to the question 130 by indicating on the graphical image of the human body where the person perceives or has perceived a symptom. The question 130 corresponds to the graphical image 128 in the graphical report 108. In other words, graphical indicators in the graphical image 128 are based on responses provided by the person to the question 130. For instance, if the person provides a response to the question 130 indicating that the person perceives pain in their left foot, the graphical image 128 includes a graphical indicator corresponding to the left foot. In some example embodiments, one or more graphical indicators in the graphical image 128 are color coded or otherwise convey detail in addition to the location on a body. In such embodiments, graphical indicators may include pain, numbness, weakness, levels of pain, and other patient characteristics.

In different embodiments, the graphical report 108 includes different types of graphs. For instance, in one example embodiment, the graphical report 108 includes one or more graphs corresponding to aspects of pain perceived by the person. For example, in this example embodiment, the graphical report 108 may include a graph corresponding to physical pain, a graph corresponding to weakness, and a graph corresponding to numbness. In some example embodiments, the graphical report 108 includes one or more graphs corresponding to aspects of mental health as perceived by the person. Furthermore, in some example embodiments, the graphical report 108 includes one or more graphs corresponding to the person's perceived quality of health, graphs corresponding to the person's perceived quality of health care, and/or graphs corresponding to other person characteristics as perceived by the person.

In some example embodiments, the graphical report 108 includes one or more graphs corresponding to objective person characteristics of the person. In other words, when the report generation engine 106 generates the graphical report 108, the report generation engine 106 generates the graphical report 108 such that at least one of the graphs in the graphical report 108 presents a third graphical indicator and a fourth graphical indicator. The third graphical indicator corresponds to a third data item set and the fourth graphical indicator corresponds to a fourth data item set. A data item in the third data item set and a data item in the fourth data item set correspond to the same objective person characteristic of the person at different times. An objective person characteristic is a characteristic of the person that can be physically measured. For instance, the person's weight is an objective person characteristic of the person. In some instance, the report generation engine 106 retrieves data representing the objective person characteristic from the HIMS 104.

Furthermore, in some example embodiments, the graphs in the graphical report 108 are subdivided into categories. For instance, in some example embodiments, the graphs in the graphical report 108 are subdivided such that the graphical report 108 includes one or more rows of graphs corresponding to person characteristics related to a specific medical field and one or more rows of graphs corresponding to person characteristics related to general health. In these example embodiments, specific medical fields may include pain, ophthalmology, podiatry, physical therapy, orthopedics, physical training, pediatric, oncology, and so on.

In different embodiments, the report generation engine 106 generates the graphical report 108 at different times. For instance, in one example embodiment, the report generation engine 106 generates the graphical report 108 in response to a command by a researcher. In another example embodiment, the report generation engine 106 generates the graphical report 108 automatically upon receiving data representing responses to questions in the survey pages 102. In yet another example embodiment, the report generation engine 106 generates the graphical report 108 in preparation for an encounter between the person and a medical caregiver. In this other example embodiment, the person may provide responses to the questions in the survey pages 102 shortly before the encounter and the report generation engine 106 may generate the graphical report 108 for review by the medical caregiver prior to the consultation. What is considered to be shortly before an encounter may depend on caregiver practice. Examples might include two days prior to the encounter, one day prior to the encounter, three hours prior to the encounter, twenty minutes prior to the encounter, and so on. Because the graphical report 108 is generated by a computing device, the time between when the person finishes responding to the questions in the survey pages 102 and when the medical caregiver is able to review the graphical report 108 may be short (e.g., a matter of seconds or minutes). Consequently, the person may be able to respond to the questions in the survey pages 102 while the person is waiting in the waiting room of an office of medical caregiver immediately prior to the consultation.

In some embodiments and as discussed in more detail herein, the questions in the survey pages 102 are presented in a first language and the graphical report 108 is presented in a second language, where the first language and the second language are different. For instance, the questions in the survey pages 102 may be presented in Spanish and the graphical report 108 is presented in English. In this way, the medical caregiver is able to review the graphical report based on responses provided by a person who does not speak the same language as the medical caregiver.

In some embodiments, information, such is responses to questions in the survey pages 102 and the graphical report 108, is stored in a clinically oriented database of the type described in U.S. patent application Ser. No. 09/671,581, filed Sep. 28, 2000, the entire disclosure of which is hereby incorporated by reference.

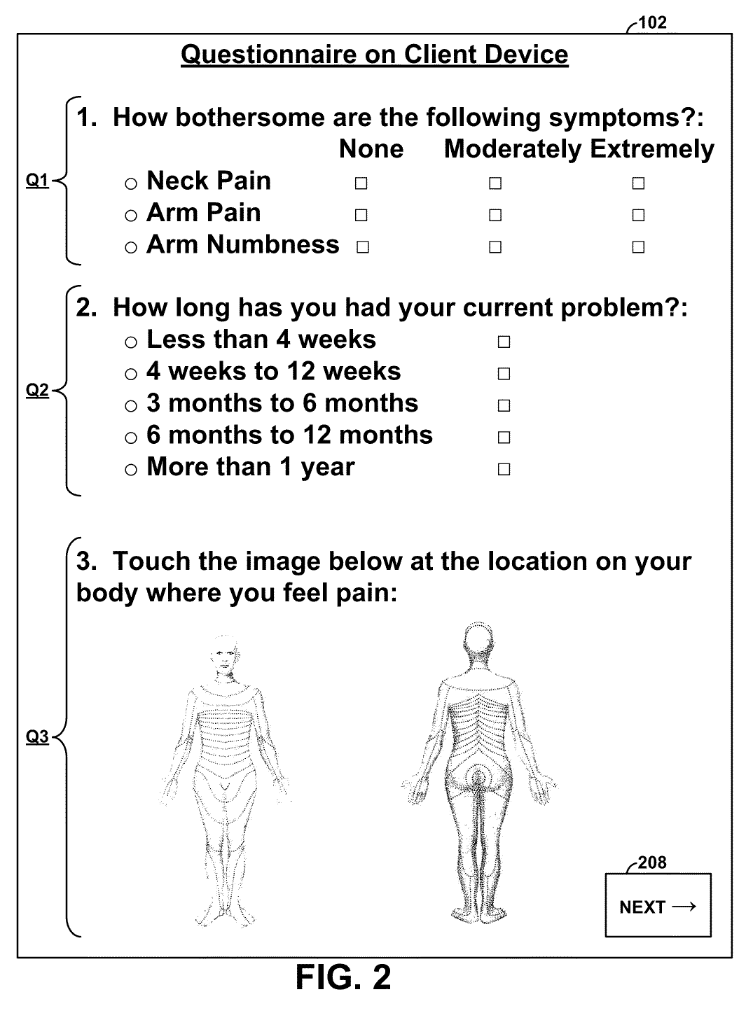

FIG. 2 illustrates an example survey page 102. In different embodiments, survey pages may appear in ways other than that illustrated in the example of FIG. 2.

As illustrated in the example of FIG. 2, the survey page 102 includes a question Q1, a question Q2, a question Q3, and a next page control 208. The question Q1 comprises three sub-questions. The person is allowed to select an answer to each of the three sub-questions of the question Q1. The question Q2 allows the person to select one of five potential answers. The question Q3 allows the person to provide an answer by indicating where on a graphical image of a human body the person perceives pain.

When selected by the person, the next page control 208 causes the client device to display a next survey page. For instance, if the survey page 102 is the first survey page in a survey, the client device displays the second survey page in the survey when the person selects the next page button 208. In some example embodiments, the client device does not display the next survey page when the person has not provided a response to each question in the survey page 102. Rather, in such embodiments, the client device indicates to the person that the user has failed to provide a response to one or more of the questions in the survey page 102. For instance, the client device may display a message indicating to the person that the person has not provided a response to the question Q2. In this way, the client device is able to ensure that the person provides a response to each of the questions in the survey page 102.

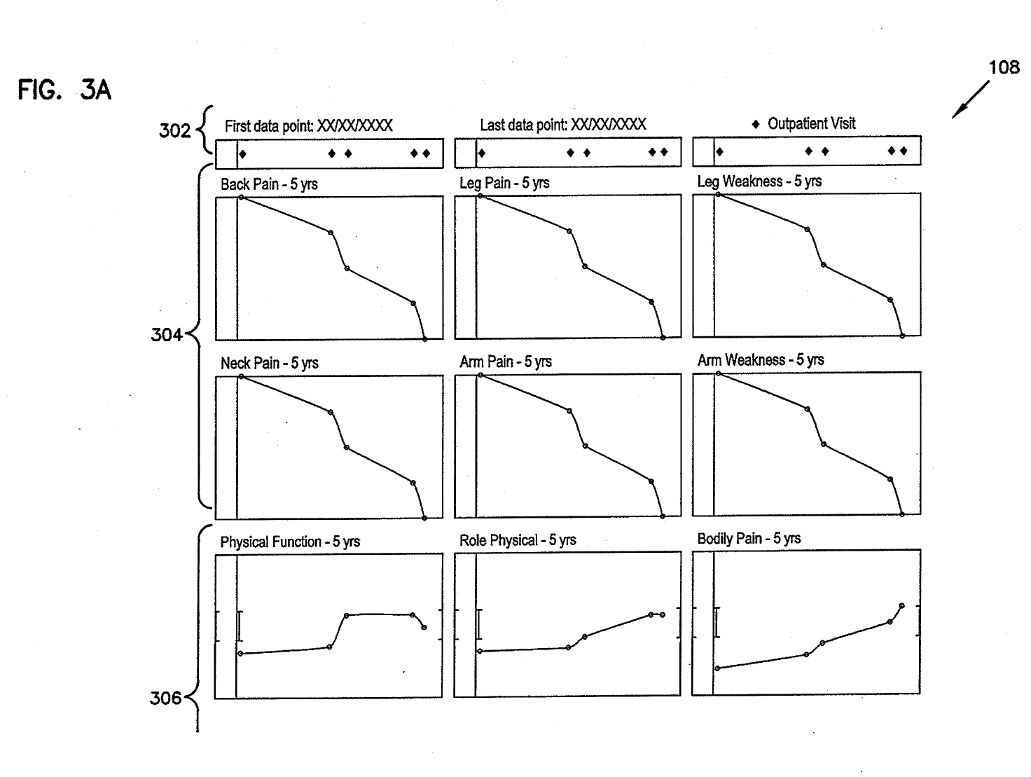

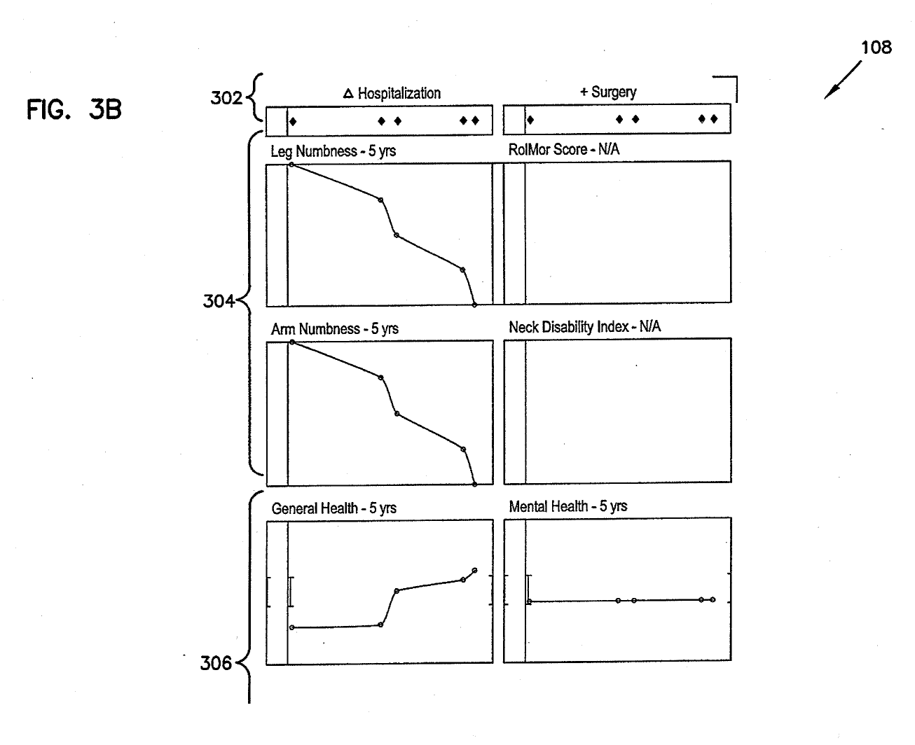

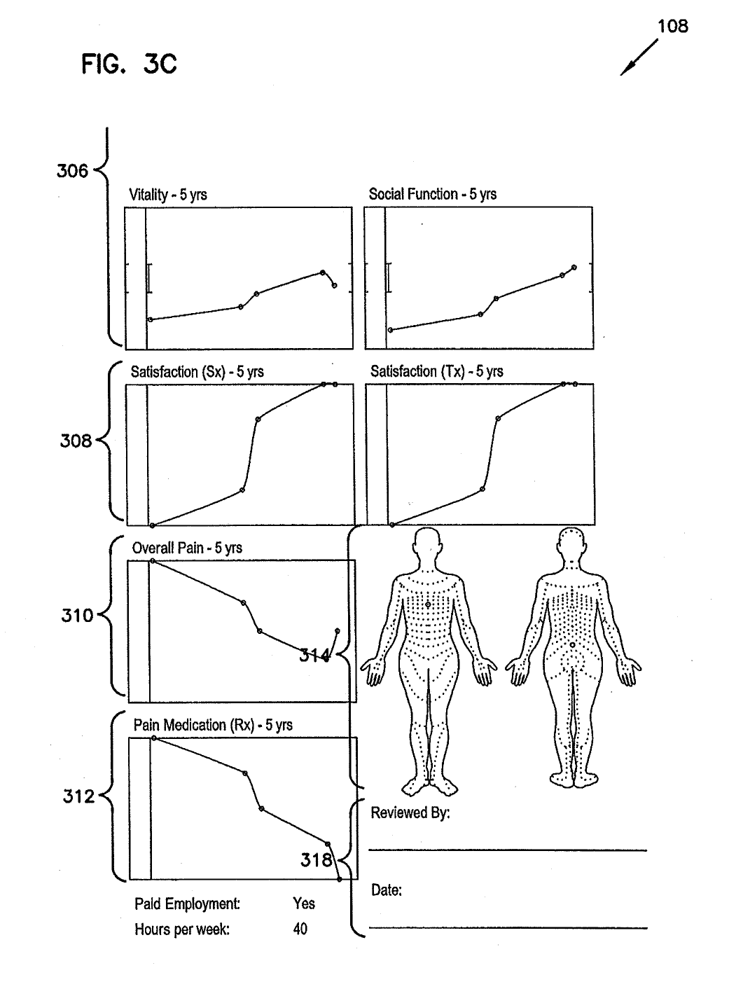

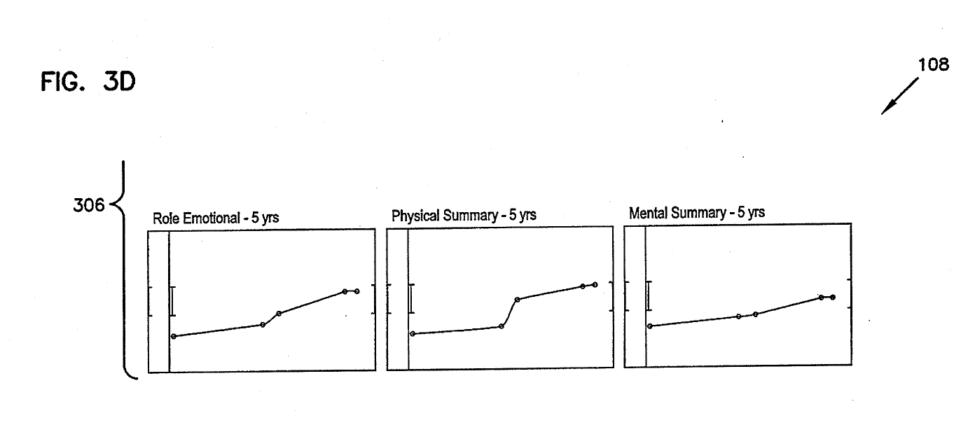

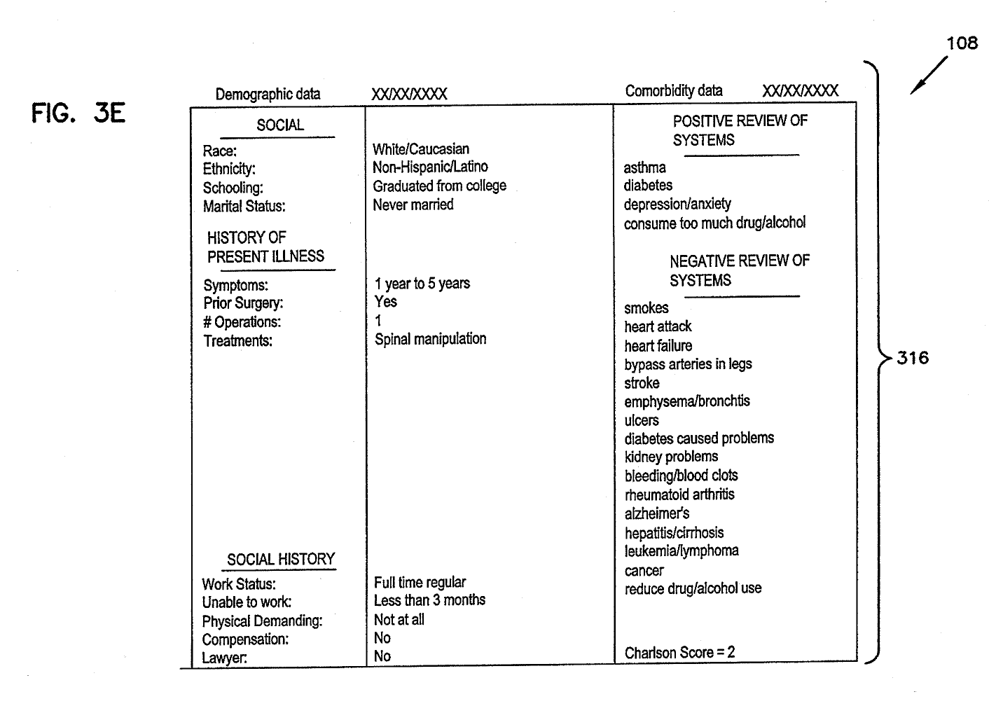

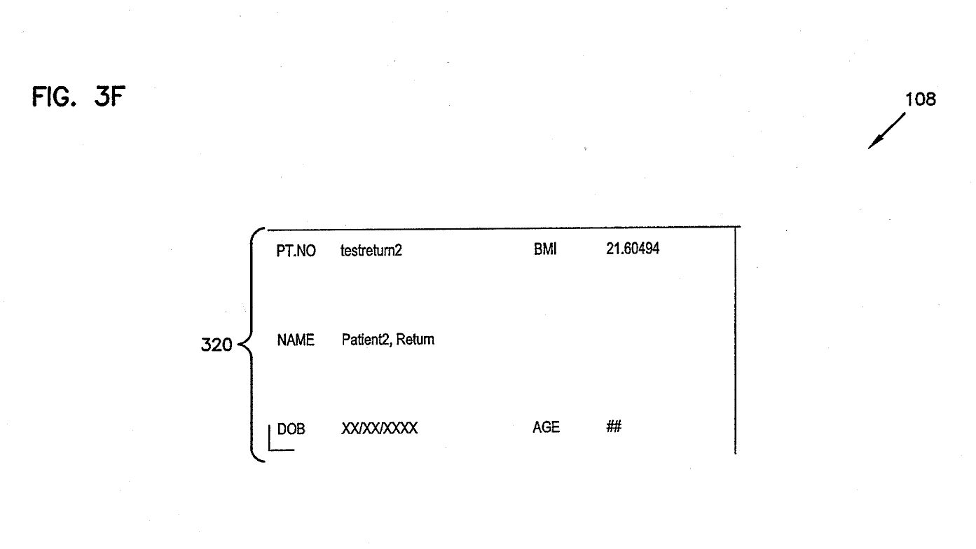

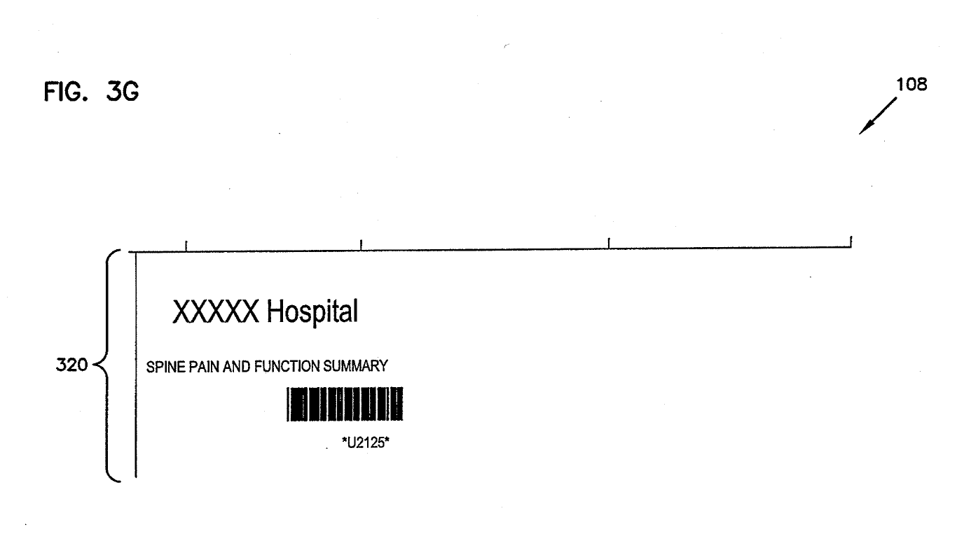

FIG. 3 illustrates an example graphical report 108. In different embodiments, reports can include different combinations of textual and/or graphical features than those illustrated in the example of FIG. 3. Moreover, in other embodiments, graphical reports include different formats for presenting information than those illustrated in the example of FIG. 3.

The graphical report 108 is an instance of a type of graphical report generated by the report generation engine 106 illustrated in the example of FIG. 1. That is, the report generation engine 106 generates the graphical report 108.

As illustrated in the example of FIG. 3, the graphical report 108 includes a plurality of timeline diagrams 302. The timeline diagrams 302 include graphical indicators corresponding to dates at which the person provided responses to questions in one or more surveys. For example, the timeline diagrams 302 may include a graphical indicator corresponding to responses provided by the person on Aug. 18, 2008, responses provided by the person on Nov. 20, 2008, responses provided by the person on Feb. 1, 2009, responses provided by the person on Mar. 4, 2009, and responses provided by the person on Jul. 17, 2009. The relative placement of the graphical indicators in the timeline diagrams 302 may help a medical caregiver understand the relative length of time between when the person provided responses to questions in the one or more surveys.

Furthermore, in the example of FIG. 3, the graphical report 108 includes a plurality of graphs. Each of the graphs includes a set of graphical indicators. In the example of FIG. 3, the graphical indicators are illustrated as solid black dots.

The graphs are subdivided into a first category 304, a second category 306, a third category 308, a fourth category 310, and a fifth category 312. The first category 304 includes graphs corresponding to person characteristics related to pain perceived by the person. The second category 306 includes graphs corresponding to person characteristics related to overall health as perceived by the person. The third category 308 includes graphs corresponding to the person's satisfaction with his or her health and the person's satisfaction with his or her medical care. The fourth category 310 includes a graph that corresponds to overall pain as experienced by the person. The fifth category 312 includes a graph that corresponds to an amount of pain medication consumed by the person.

Although five categories are illustrated in the example of FIG. 3, in other embodiments, the graphical report 108 includes a single category of graphs or another number of categories of graphs. For instance, in various embodiments, graphical reports can include information relevant to one specialty or more than one specialty. Furthermore, in other embodiments, graphical reports include graphical features other than graphs. For instance, in some embodiments, graphical reports include charts, histograms, pie charts, bar charts, scatter diagrams, three-dimensional diagrams, and/or other types of graphical features that present data.

In some embodiments, graphs in the first category 304, the fourth category 310, and the fifth category 312 are substituted with graphs corresponding to other medical specialties. For instance, in one example alternative embodiment, the graphical report 108 includes graphs corresponding to aspects of hand function instead of pain. In such embodiments, the graphs in the second category 306 and the third category 308 remain in the graphical report 108 despite the substitution of graphs corresponding to person characteristics relevant to other medical specialties.

The graphical report 108 also includes a graphical image 314 of the human body. The graphical image 314 includes graphical indicators indicating where the person perceives or has perceived a symptom to be occurring. In the example of FIG. 3, the graphical indicators are illustrated as solid black dots. In other embodiments, the graphical report 108 includes images of specific parts of the human anatomy, such as the neck, face, arms, legs, head, and other parts of the human anatomy. Some embodiments enable the person to zoom in to or zoom out from particular parts of the graphical image 314 to show where the symptom is occurring with greater or less specificity. Furthermore, in some embodiments, the graphical report 108 includes graphical images of two or more different parts of the human anatomy. For instance, the graphical report 108 may include a graphical image of a hand and a graphical image of a foot.

Furthermore, the graphical report 108 includes a person background area 316. The person background area 316 includes information about the background of the person. In the example of FIG. 3, the person background area 316 includes demographic data. The demographic data includes race, ethnicity, schooling, marital status, employment status, whether the person is insured and what type of insurance the person has, who is covering medical expenses, whether the person is receiving disability, whether the person has retained an attorney, and other information about the person. In other embodiments, the graphical report 108 includes other types of demographic information such as religion, education level, and so on. In addition, the person background area 316 includes a history of a present illness of the person and a social history of the person. In an example embodiment, the person background area 316 includes comorbidity data. Examples of comorbidity data include a positive review of systems and a negative review of systems. Conditions listed under the positive review of systems include conditions that the person has. Conditions listed under the negative review of systems include conditions that the person does not have. In another example embodiment, the person background area 316 includes a Charlson score that summarizes the one year mortality for the person. It should be appreciated that not all of the information shown in the example of FIG. 3 is included in the graphical reports generated by some embodiments. For instance, some example embodiments do not include comorbidity data or a particular type of comorbidity data.

The graphical report 108 also includes an acknowledgment area 318. The acknowledgment area 318 is an area into which a medical caregiver inserts acknowledgment data. The acknowledgment data is data indicating that the medical caregiver has reviewed the graphical report 108. In different embodiments, the acknowledgment data assumes different forms. For instance, in the example of FIG. 3, the acknowledgment data may assume the form of a hand written or electronic signature and a date. An electronic signature is a digital representation of an individual's signature as the individual would write his or her signature on paper. As explained below, in other embodiments, the acknowledgment data may assume the form of a digital signature. A digital signature is a set of data created by a person using an identity credential of the person (e.g., secret password, fingerprint, retina scan, etc.). The digital signature contains encrypted information used by a computer to verify that a target set of data (e.g., the graphical report) has not been changed after the digital signature was created.

In addition, the graphical report 108 includes a report identification area 320. The report identification area 320 includes information that identifies the person associated with the graphical report 108, a location where the graphical report 108 was generated, and a type of the graphical report 108. For instance, in the example of FIG. 3, the report identification area 320 includes a patient number “p12345,” a name of the person “Doe, John,” a date of birth of the patient, and an age of the person. In the example of FIG. 3, the report identification area 320 also indicates “General Hospital Medical Center, Seattle, Wash.” as a location where the report was generated. Furthermore, in the example of FIG. 3, the report identification area 320 indicates the type of the graphical report as “Spine Pain and Function Summary.”

Although certain types of information and sections in the graphical report 108 are discussed, other embodiments can include different information and sections in graphical reports. For instance, in one example embodiment, graphical reports do not include the acknowledgment area 318 or the report identification area 320.

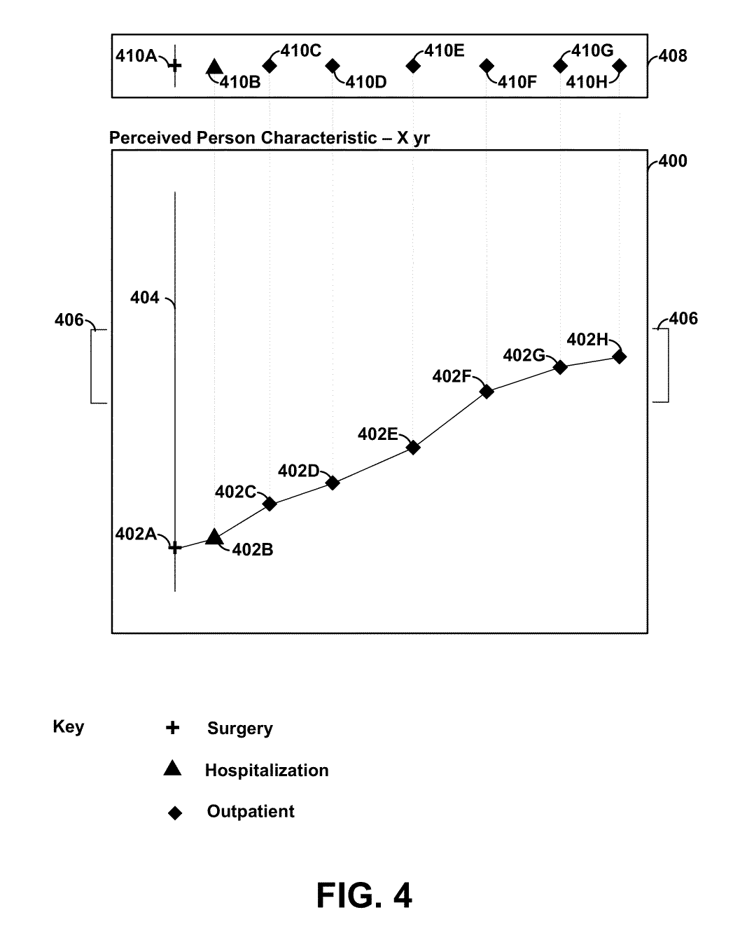

FIG. 4 illustrates an example graph 400 in the graphical report 108. In different embodiments, graphs in graphical reports appear in ways different than that illustrated in the example of FIG. 4.

As illustrated in the example of FIG. 4, the graph 400 includes a set of graphical indicators 402A-402H (collectively, “graphical indicators 402”). Each of the graphical indicators 402 corresponds to one or more data items corresponding to one or more questions in one or more surveys. The graphical indicators indicate a magnitude of the same perceived person characteristic as perceived by the person at different times. For example, each of the graphical indicators 402 may indicate a magnitude of arm numbness as perceived by the person at a different time. In other example embodiments, one or more of the graphical indicators 402 indicate a magnitude of the same objective person characteristic of the person, such as weight, at different times.

The graphical indicators 402 are measured against a magnitude axis 404. In some example embodiments, graphs in graphical reports also include time axes. In such example embodiments, the time axes may be horizontal lines across the bottom of the graphs.

In the example of FIG. 4, the graphical indicators 402 further indicate a type of medical encounter associated with each of the graphical indicators 402. For instance, in some example embodiments, each time the person prepares for a medical encounter, the person responds to questions in a single survey. For instance, the graphical indicator 402A indicates a magnitude of the perceived person characteristic as perceived by the person prior to a surgical intervention, the graphical indicator 402B indicates a magnitude of the perceived person characteristic as perceived by the person prior to a hospital encounter, and graphical indicators 402C through 402H indicate magnitudes of the perceived person characteristic as perceived by the person prior to outpatient encounters. Other types of encounters are possible. Furthermore, in some embodiments, the graphical indicators 402 do not indicate types of medical encounters.

The graph 400 also includes graphical indicators 406. The graphical indicators 406 indicate a normative range for the perceived person characteristic corresponding to the graph 400. The normative range for a perceived person characteristic is a range of magnitude of the perceived person characteristic that most people in a community or among a population perceive. As illustrated in the example of FIG. 4, the graphical indicators 402F, 402G, and 402H indicate magnitudes of the perceived person characteristic that fall within the normative range indicated by the graphical indicators 406. Furthermore, as illustrated in the example of FIG. 4, the graphical indicators 402A, 402B, 402C, 402D, and 402E indicate magnitudes of the perceived person characteristic that fall outside the normative range indicated by the graphical indicators 406. A graph that shows whether the perceived person characteristic is within the normative range may help the person or the medical caregiver to understand whether a therapy has been successful. Example types of therapies include any type of management or care for combating physical or mental diseases, disorders, traumas, and the like.

In different example embodiments, the graph 400 includes other types of graphical indicators to indicate normative ranges for the perceived patient characteristics. For instance, in one example embodiment, the graph 400 includes one or more trend lines that indicate typical progress of patients in response to a therapy, such as a surgery or after beginning a course of physical therapy or psychotherapy. In other embodiments, normative ranges are indicated by text. Furthermore, some embodiments do not include graphical and/or textual indicators indicating normative ranges.

The example of FIG. 4 also includes a timeline diagram 408. The timeline diagram 408 includes graphical indicators 410A-410H (collectively, “graphical indicators 410). The relative positions of the graphical indicators 410 indicate relative times when the person responded to questions in the survey. In other embodiments, each of the graphical indicators 410 indicates an actual data of a medical encounter. The example of FIG. 4 also includes lines showing the correlation between the graphical indicators 410 in the timeline diagram 408 and the graphical indicators 402 in the graph 400. In some embodiments, a single timeline diagram can provide a timeline for multiple graphs. For example, in the example of FIG. 3, the timeline graphs 302 correspond to or provide the x-axis for each of the graphs presented in the column below it.

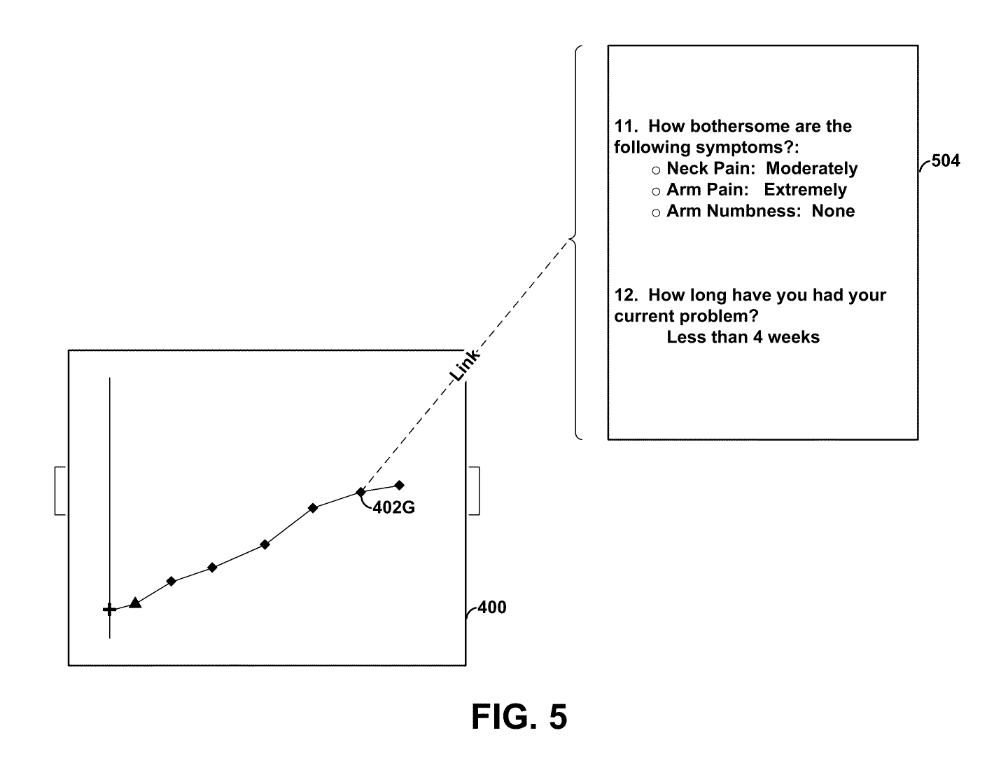

FIG. 5 is a schematic diagram illustrating an example link between a graphical indicator 402G in a graph 400 and survey responses corresponding to the graphical indicator. As illustrated in the example of FIG. 5, possible embodiments associate a link with one or more of the graphical indicates that relate to a data set. In different embodiments, graphs appear in different ways and links between graphical indicators and underlying survey responses are differently implemented.

The graph 400 is similar in design and content as the graph 400 illustrated in the example of FIG. 4. The graph 400 includes a set of graphical indicators that indicate magnitudes of a person characteristic as perceived by the person. For the sake of clarity, in the example of FIG. 5, only the graphical indicator 402G bears a reference numeral.

At least some of the graphical indicators in the graph 400 are linked to responses to questions that correspond to the graphical indicators. For instance, the graphical indicator 402G corresponds to responses to questions from which the graphical indicator 402G was generated. In the example of FIG. 5, the graphical indicator 402G corresponds to a response to a question regarding how bothersome neck pain, arm pain, and arm numbness have been to the person and the graphical indicator 402G corresponds to a response to a question regarding how long the person has had the current problem.

In different embodiments, graphical indicators in the graph 400 are linked to questions that correspond to the graphical indicators in different ways. For instance, in various example embodiments, graphical indicators in the graph 400 are linked to questions that correspond to the graphical indicators with hyperlinks, globally unique identifiers (GUIDs), uniform resource identifiers (URIs), uniform resource locators (URLs), memory pointers, and other types of data that identify other data and/or identify locations where other data is stored.

In the example embodiment illustrated in the example of FIG. 5, a computing device presents the graph 400 on an interactive user interface, such as a monitor or a touch screen. When a user selects a graphical indicator in the graph 400 linked to responses to questions corresponding to the graphical indicator, the computing device displays a graphical area 504 containing the responses and the questions corresponding to the graphical indicator.

In different embodiments, the computing device presents the graphical area 504 in different ways. For instance, in one example embodiment, the computing device presents the graphical area 504 as a pop-up window. In another example embodiment, the computing device displays the graphical area 504 semi-transparently in front of the graph 400.

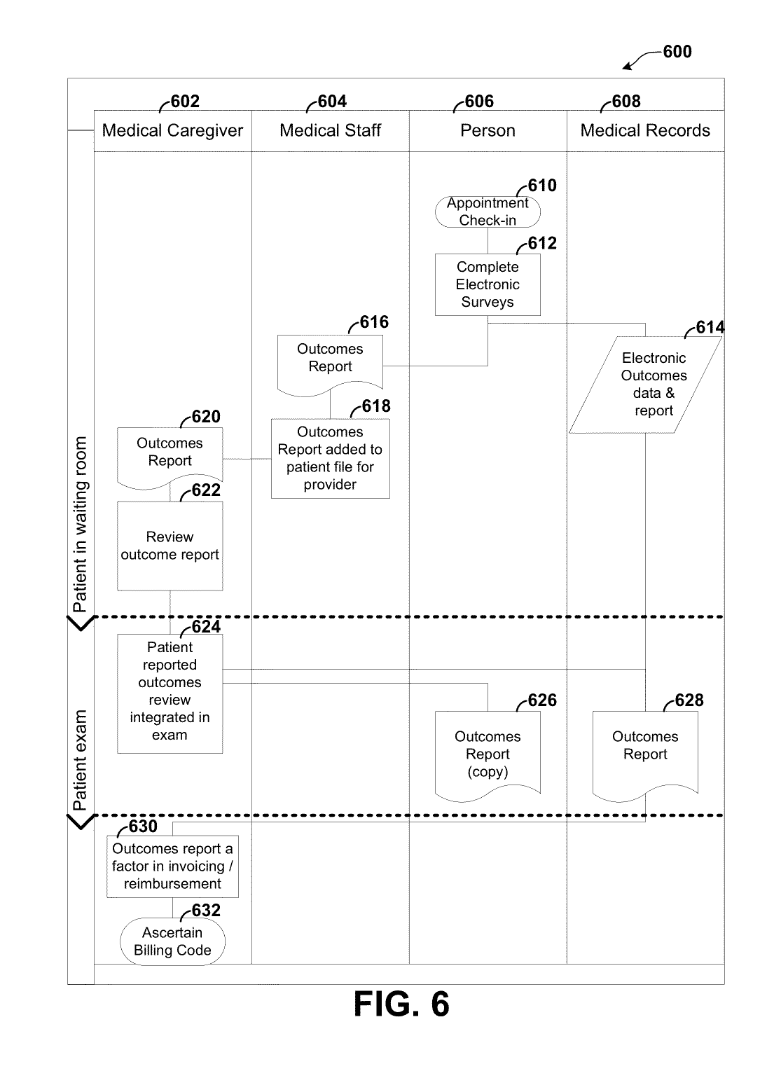

FIG. 6 is a schematic flow diagram illustrating an example operation 600 to generate and use a graphical report. Other embodiments use other operations to generate and use graphical reports.

In the example of FIG. 6, there are four participants: a medical caregiver 602, medical staff 604, a person 606, and a medical records system 608. Other embodiments might include more or fewer participants. For instance, another embodiment may only include the medical caregiver 602 and the person 606. In another instance, an embodiment may include an additional third party.

The patient is a person undergoing or seeking medical attention. The medical caregiver 602 is a person who provides medical care to the person 606, such as a physician, nurse, trainer, chiropractor, surgeon, physical therapist, physiatrist, psychologist, optometrist, dentist, ophthalmologist, physician assistant, dental hygienist, or other type of person. In other embodiments, the role of the medical caregiver 602 is taken by a researcher or another type of person. The medical staff 604 provides assistance to the medical caregiver 602. The medical staff 604 is located at a same location as the medical caregiver 602. The medical records system 608 manages medical records. The medical records system 608 may be located at a variety of places, including the same location as the medical caregiver 602 or a location remote from the medical caregiver 602.

The operation 600 starts when the person 606 checks in at an office of the medical caregiver 602 for an appointment (610). After the person 606 checks in for the appointment, the person 606 completes one or more electronic surveys (612). In other words, the person 606 provides responses to questions in one or more surveys presented to the patient by a computing device.

When the person 606 completes the one or more electronic surveys, the medical records system 608 stores data items corresponding to the responses to the questions in the electronic surveys and an outcomes report based on the responses to the questions in the electronic surveys (614). The outcomes report is a graphical report similar to the graphical report 108 illustrated in the example of FIG. 3. Moreover, the outcomes report is generated by the report generation engine 106 in the example of FIG. 1. In the example of FIG. 6, the graphical report is termed an outcomes report because the graphs in the graphical report present graphical indicators that indicate the outcome of the person after a medical intervention or trauma. Example types of medical interventions include surgeries, physical examinations, operations, physical therapy sessions, psychotherapy sessions, and so on. Example types of trauma include brain injuries, heart attacks, strokes, broken bones, blunt impact wounds, crush wounds, sexual abuse, psychological abuse, traumatic experiences, and other types of injury whether mental, psychic, physical, or the like.

In addition, the medical staff 604 receives a copy of the outcomes report (616). For instance, in a first example embodiment, the medical staff 604 receives the copy of the outcomes report from a printer located at an office of the medical caregiver 602. In another example embodiment, the medical staff 604 receives the copy of the outcomes report on a computing device. Upon receiving the copy of the outcomes report, the medical staff 604 adds the copy of the outcomes report to a file for the person 606 for the review by the medical caregiver 602 (618). For example, the medical staff 604 adds a printed copy of the outcomes report to a physical patient history file. In another example, the medical staff 604 adds an electronic copy of the outcomes report to an electronic patient history file.

After the medical staff 604 adds the copy of the outcomes report to a file for the person 606, the medical caregiver 602 receives the copy of the outcomes report (620). When the medical caregiver 602 has received the copy of the outcomes report, the medical caregiver 602 reviews the copy of the outcomes report to identify trends regarding the perception of the person characteristics of the person 606 by the person 606 (622). In the example of FIG. 6, steps 610-622 occur while the person 606 is in a waiting room at the office of the medical caregiver 602.

After the medical caregiver 602 reviews the copy of the outcomes report, the medical caregiver 602 conducts a medical examination of the person 606. During the medical examination of the patient, the medical caregiver 602 integrates the patient reported outcomes indicated by the outcomes report into the medical examination (624). For instance, the medical caregiver 602 may ask further questions about why the person 606 is perceiving a patient characteristic to have become better or worse. Furthermore, during the medical examination, the medical caregiver 602 provides a copy of the outcomes report to the person 606 (626). The person 606 is able to keep the copy of the outcomes report for the patient's records.

In addition, during the medical examination, the medical caregiver 602 generates an acknowledged version of the outcomes report by adding acknowledgment data to a copy of the outcomes report and provides the acknowledged version of the outcomes report to the medical records system 608 (628). As mentioned above, the acknowledgment data assumes different forms in different embodiments. For instance, the acknowledgment data may be a handwritten signature of the medical caregiver 602. In this instance, the medical caregiver 602 provides the acknowledged version of the outcomes report to the medical records system 608 by scanning the acknowledged version of the outcomes report. In this instance, the medical records system 608 stores the acknowledged version of the outcomes report as a digital image of a page upon which the graphical report is printed and upon which the medical caregiver 602 has indicated that the medical caregiver 602 has reviewed the outcomes report.

At a time after the medical encounter with the person 606, the medical caregiver 602 uses the outcomes report as a factor for invoicing and/or reimbursement (630). For example, some insurance companies require providers to provide evidence of the medical services provided before compensating the providers for the medical services. In this example, discussing the outcomes report with the person 606 is a type of medical service. Because the medical caregiver 602 is able to use the review of the outcomes report as a factor for invoicing and/or reimbursement, the medical caregiver 602 uses the review of the outcomes report when ascertaining at least one code denoting the medical services provided (632). Example types of codes include Evaluation/Management (E/M) codes and Current Procedural Terminology (CPT) codes. Payers use such codes when determining how much to compensate providers for medical services provided.

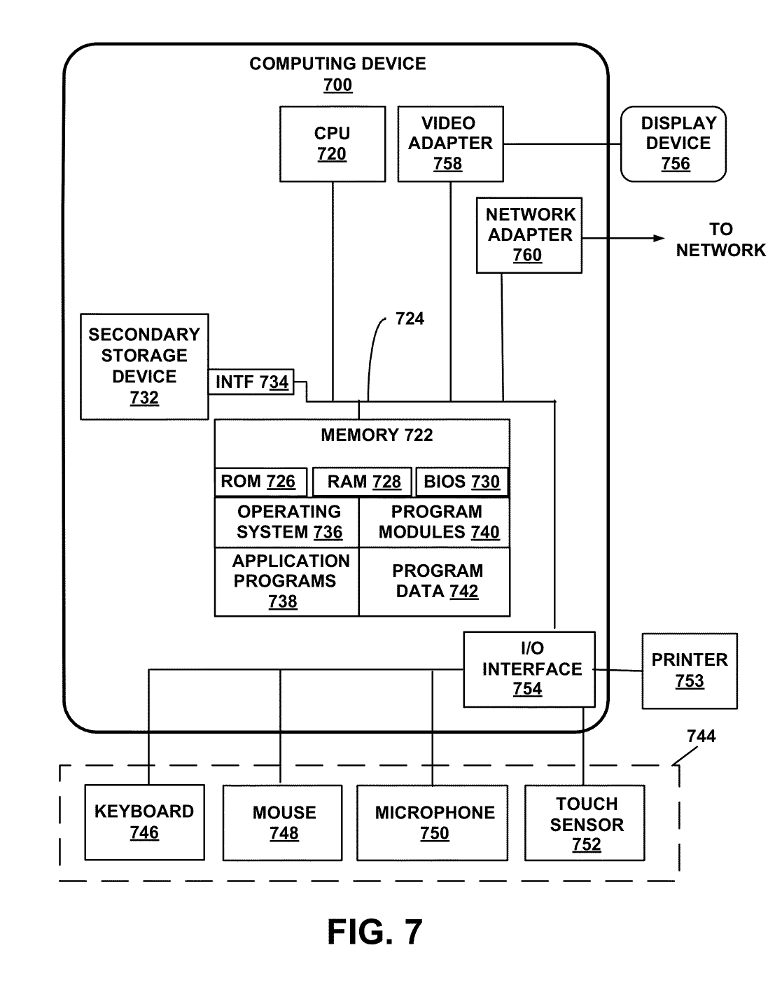

FIG. 7 illustrates an exemplary architecture of a computing device 700 that can be used to implement aspects of the present disclosure, including a server computing system, a personal computing system, a client computing system, and/or other computing systems discussed in this disclosure. The computing device 700 is used to execute the operating system, application programs, and software modules (including the software engines) described herein.

The computing device 700 includes, in some embodiments, at least one processing device 720. A variety of processing devices are available from a variety of manufacturers, for example, Intel or Advanced Micro Devices. In this example, the computing device 700 also includes a system memory 722, and a system bus 724 that couples various system components including the system memory 722 to the processing device 720. The system bus 724 is one of any number of types of bus structures including a memory bus, or memory controller; a peripheral bus; and a local bus using any of a variety of bus architectures.

The system memory 722 includes read only memory 726 and random access memory 728. A basic input/output system 730, containing the basic routines that act to transfer information within the computing device 700, such as during start up, is typically stored in the read only memory 726.

The computing device 700 also includes a secondary storage device 732, such as a hard disk drive, for storing digital data. The secondary storage device 732 is connected to the system bus 724 by a secondary storage interface 734. The secondary storage device 732 and associated computer readable media provide nonvolatile storage of software instructions (including application programs and program modules), data structures, and other data for the computing device 700.

Although the exemplary environment described herein employs a hard disk drive as a secondary storage device, other types of computer readable media are used in other embodiments. Examples of these other types of computer readable media include magnetic cassettes, flash memory cards, digital video disks, Bernoulli cartridges, compact disc read only memories, digital versatile disk read only memories, random access memories, or read only memories.

A number of program modules can be stored in the secondary storage device 732 or the system memory 722, including an operating system 736, one or more application programs 738, other program modules 740, and program data 742.

In some embodiments, a person provides inputs to the computing device 700 through one or more input devices 744. Examples of the input devices 744 include a keyboard 746, a mouse 748, a microphone 750, and a touch sensor 752 (such as a touchpad or touch sensitive display). Other embodiments include other input devices. The input devices 744 are connected to the processing device 720 through an input/output (I/O) interface 754. The I/O interface 754 is coupled to the system bus 724. The input devices 744 are connected to the I/O interface 754 by any number of input/output interfaces, such as a parallel port, serial port, game port, or a universal serial bus. Wireless communication between input devices and I/O interface 754 is possible as well, and includes infrared, BLUETOOTH® wireless technology, 802.11a/b/g/n, cellular, or other radio frequency communication systems in some possible embodiments. The I/O interface 754 also communicates with a printer 753.

In this example embodiment, a display device 756, such as a monitor, liquid crystal display device, projector, or touch screen display device, is also connected to the system bus 724 via an interface, such as a video adapter 758. In addition to the display device 756, the computing device 700 can include various other peripheral devices (not shown), such as speakers or a printer.

When used in a local area networking environment or a wide area networking environment (such as the Internet), the computing device 700 is typically connected to the network through a network interface or an adapter 760. Other possible embodiments use other communication devices. For example, some embodiments of the computing device 700 include a modem for communicating across the network.

The computing device 700 typically includes at least some form of computer-readable media. Computer readable media includes volatile and nonvolatile, removable and non-removable media implemented in any device configured to store information such as software instructions, data structures, program modules or other data. Computer readable media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 700.

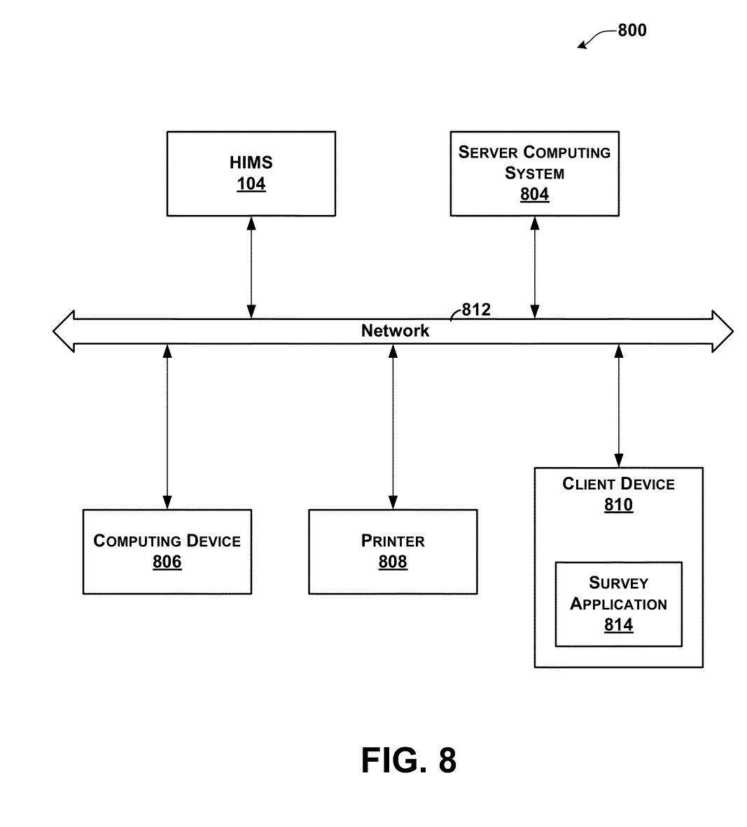

FIG. 8 is a schematic logical block diagram illustrating one example system 800 for generating a person outcome report. In different embodiments, other systems for generating a person outcome report include different components.

The system 800 includes a HIMS 104, a server computing system 804, a computing device 806, a printer 808, a client device 810, and a network 812. It should be appreciated that in some instances, the system 800 includes additional components.

The HIMS 104 stores and/or provides access to hospital information and/or patient records. In different embodiments, the HIMS 104 is implemented in different ways. For instance, the HIMS 104 may be implemented as a standalone server device, a set of server devices at one or more server farms, a set of server devices at a hospital, a mainframe computer, or implemented as one or more other types of computing devices. In different embodiments, the HIMS 104 may be located at different locations. For instance, the HIMS 104 may be located at a location local to a medical caregiver, a hospital, a remote server farm, or another location. It should be appreciated that other embodiments may not include the HIMS 104.

In at least some possible embodiments, the server computing system 804 implements the report generation engine 106 illustrated in the example of FIG. 1. In other words, the server computing system 804 receives data representing responses to questions in one or more surveys, obtains data items corresponding to the responses, and generates a graphical report based on the responses. In different embodiments, the server computing system 804 is implemented in different ways. For instance, the server computing system 804 may be implemented as a standalone server device, a set of server devices at one or more server farms, a set of server devices at a hospital, a mainframe computer, or implemented as one or more other types of computing devices. Furthermore, in different embodiments, the server computing system 804 may be located at different locations. For instance, the server computing system 804 may be located at a location local to a medical caregiver or a location remote from the medical caregiver, such as a server farm.

The computing device 806 enables various people to interact with graphical reports. For instance, the computing device 806 may display a graphical report to a medical caregiver for review. In different embodiments, the computing device 806 is implemented in different ways. For instance, the computing device 806 may be implemented as a desktop computer, a laptop computer, a netbook computer, a personal digital assistant, or another type of computing device.

In some embodiments, the computing device 806 is used to customize one or more surveys. For instance, in one example embodiment, a medical caregiver uses the computing device 806 to allow or disallow people to skip survey questions. In another example embodiment, a medical caregiver uses the computing device 806 to create custom survey questions. In yet another example embodiment, a medical caregiver uses the computing device 806 to select a welcome screen for a survey. In yet another example embodiment, a medical caregiver uses the computing device 806 to select how many copies of graphical reports should be automatically printed after a person completes a survey. In yet another example embodiment, a medical caregiver uses the computing system 806 to view statistics of persons treated by the medical caregiver. Example statistics include race, gender, percentage of patients reporting person characteristics within normative ranges after a given time, and other types of statistical information. In yet another example embodiment, a medical caregiver uses the computing device 806 to view aggregate graphical reports. In yet another example embodiment, a medical caregiver uses the computing device 806 to add and/or edit patient information. In yet another example embodiment, a medical caregiver uses the computing device 806 to reprint graphical reports.

The printer 808 prints graphical reports. In different embodiments, the system 800 includes different types of printers. For instance, the printer 808 may be a laser printer, a ink jet printer, a fax machine, a copier machine, or another type of printer.

The client device 810 executes a survey application 814. The survey application 814 displays questions in one or more surveys to a person and receives responses to the questions from the person. Furthermore, the survey application 814 sends data representing the responses to the server computing system 804 via the network 812.

In different embodiments, the client device 810 is implemented as different types of computing devices. For example, the client device 810 may be implemented as a tablet computer, a desktop computer, a netbook computer, a laptop computer, a kiosk, a personal digital assistant, a smart phone, or another type of computing device. In some embodiments, the client device 810 is implemented on the same hardware platform as the computing device 806. Furthermore, in different embodiments, the survey application 814 is implemented in different ways. For instance, in one example embodiment, the survey application 814 is implemented as a set of software instructions executed by a processing unit of the client device 810. In another example embodiment, the survey application 814 is implemented at least in part by one or more Application Specific Integrated Circuits (ASICS).

In different embodiments, the client device 810 is located in different locations. For instance, the client device 810 may be located at an office of a medical caregiver, at a home of a person, at an office of a person, or at another location.

The network 812 facilitates electronic communication between the HIMS 104, the server computing system 804, the computing device 806, the printer 808, and the client device 810. In different embodiments, the network 812 is implemented in different ways. For instance, in one example embodiment, the network 812 is a local area network. In other example embodiments, the network 812 is a wide area network. In different embodiments, the network 812 may include wired and/or wireless communication links.

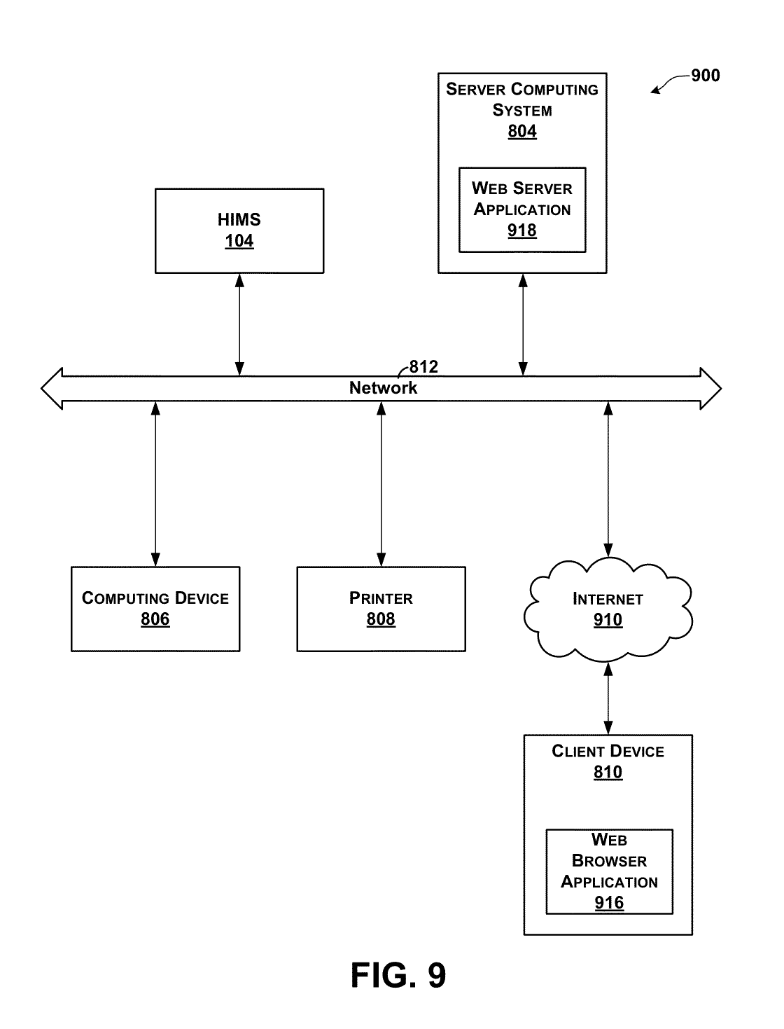

FIG. 9 is a schematic logical block diagram illustrating another example system 900 for generating a person outcome report. In different embodiments, other systems for generating a person outcome report include different components.

The system 900 includes a HIMS 104, a server computing system 804, a computing device 806, a printer 808, an Internet 910, a client device 810, and a network 812. The HIMS 104 is similar in function and implementation to the HIMS 104 described with reference to the example of FIG. 8. The computing device 806 is likewise similar in function and implementation as the computing device 806 described with reference to the example of FIG. 8. In addition, the printer 808 is similar in function and implementation to the printer 808 in the example of FIG. 8. The network 812 is similar in function and implementation to the network 812 in the example of FIG. 8.

The client device 810 operates a web browser application 916. The web browser application 916 renders and displays resources available through the Internet 910. For instance, the web browser application 916 may be the Microsoft Internet Explorer web browser application, the Mozilla Firefox web browser application, or another web browser application.

In general, the server computing system 804 provides the same functionality as the server computing system 804 illustrated in the example of FIG. 8. However, the server computing system 804 operates a web server application 918. The web server application 918 hosts one or more survey pages. To display questions in a survey to a person, the web browser application 916 sends one or more requests via the Internet 910 and the network 812 for the one or more survey pages hosted by the web server application 918. Upon receiving the requests, the web server application 918 sends the survey pages to the web browser application 916. When the web browser application 916 receives the survey pages, the web browser application 916 displays the survey pages to the person. To submit data representing responses to questions in the survey pages, the web browser application 916 sends the data to the web server application 918.

In some implementations, the web server application 918 sends survey pages conforming to a first language to the web browser application 916. For instance, the web server application 918 may send survey pages in French to the web browser application 916. In such implementations, each potential response is associated with a numerical value. Because each potential response is associated with a numerical value, the server computing system 804 is able to generate the graphical report in a second language. For instance, the server computing system 804 may generate the graphical report in Japanese.

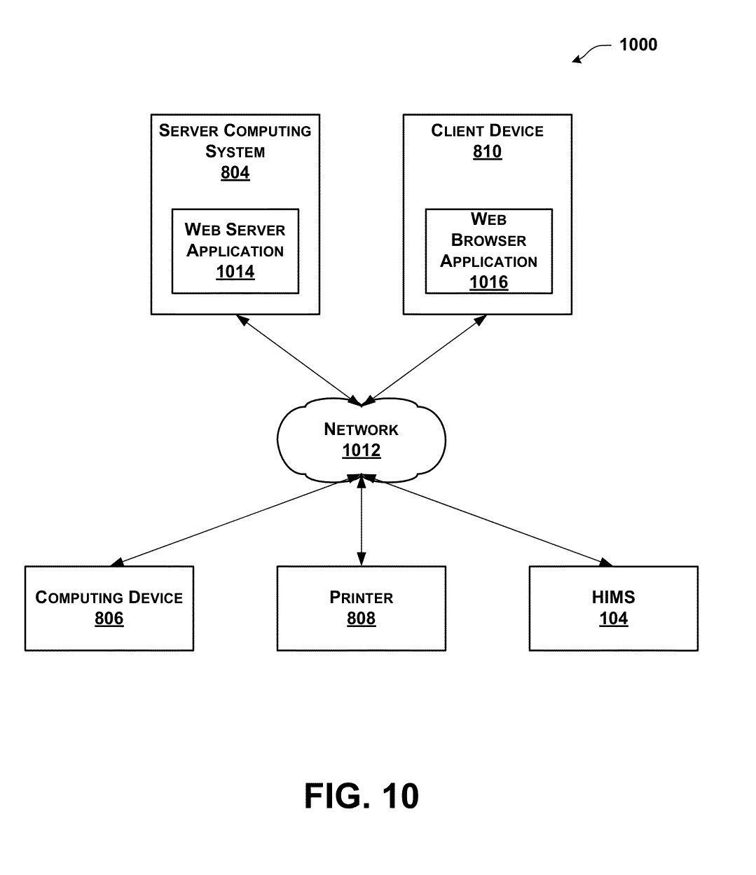

FIG. 10 is a schematic logical block diagram illustrating yet another example system 1000 for generating a person outcome report. In different embodiments, other systems for generating a person outcome report include different components.

The system 1000 includes a HIMS 104, a server computing system 804, a computing device 806, a printer 808, a client device 810, and a network 1012. The server computing system 804 operates a web server application 1014. The client device 810 operates a web browser application 1016. The HIMS 104, the server computing system 804, the computing device 806, the printer 808, the client device 810, the web server application 1014, and the web browser application 1016 are similar in functionality and implementation to the corresponding components of the system 900 illustrated in the example of FIGS. 8 and 9.

However, the network 1012 is conceptualized as a cloud. In other words, implementation details of the network 1012 are abstracted away. Consequently, services provided by the HIMS 104 and the server computing system 804 to the computing device 806, the printer 808, and the client device 810 appear to be provided by the cloud. Thus, an application to generate graphical reports is an instance of cloud computing in which a third party provides the services of one or more components of the system 1000.

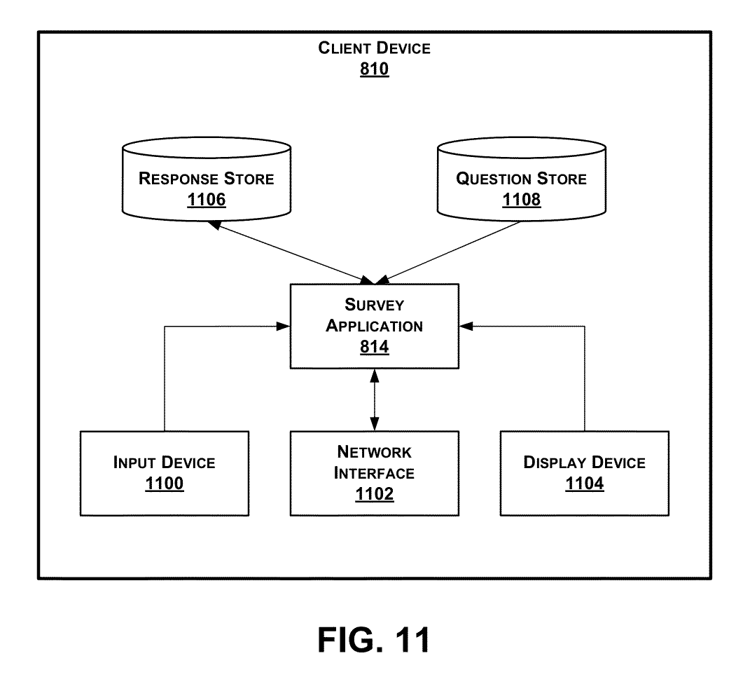

FIG. 11 is a schematic logical block diagram illustrating example details of the client device 810 (FIG. 8). In other embodiments, other client devices are implemented in different ways.

As illustrated in the example of FIG. 11, the client device 810 comprises the survey application 814, an input device 1100, a network interface 1102, a display device 1104, a response store 1106, and a question store 1108.

The input device 1100 enables the person to provide input to the survey application 814. The input device 1100 may be different types of input devices in different implementations. For instance, the input device 1100 may be a mouse, a touch screen, a trackball, a stylus, a keyboard, a keypad, a voice recognition system, and other types of devices that receive input from the user.

The network interface 1102 enables the client device 810 to communicate on a computer network. The network interface 1102 may be different types of network interface in different embodiments. For instance, the network interface 1102 may be an Ethernet interface card, a fiber optic interface card, a wireless interface card, or another type of network interface.

The display device 1104 physically displays information to the person. The display device 1104 may be different types of display device in different embodiments. For instance, the display device 1104 may be a cathode ray tube (CRT) monitor, a liquid crystal display (LCD) screen, a plasma screen, a light emitting diode (LED) screen, an organic LED screen, or another type of device that physically displays information to the person.

The question store 1108 stores data representing questions in one or more surveys. The question store 1108 is implemented in different ways in different embodiments. For instance, the question store 1108 is implemented as a relational database in one example implementation. In another example implementation, the question store 1108 is implemented as a set of fixed Hypertext Markup Language (HTML) pages.

Furthermore, in some embodiments, the question store 1108 stores questions in one or more surveys in a plurality of languages. For example, the question store 1108 may store copies of each question in a survey in French, Spanish, Korean, Chinese, German, Russian, English, and Hindi. In different embodiments, the question store 1108 stores questions to surveys in the plurality of languages in different ways. For example, in one embodiment, the question store 1108 comprises a table for each question in a survey. In this example, each row in the table for a question stores a version of the question in a different language. In instances where one of the surveys is a SF-series survey from QualityMetric, Inc., the question store 1108 stores different language versions of the SF-series survey approved by QualityMetric, Inc.

The response store 1106 stores responses to questions. The question store 1106 is implemented in different ways in different embodiments. For instance, the response store 1106 is implemented as a relational database in one example implementation. In another example implementation, the response store 1106 is implemented as a text file.

The survey application 814 retrieves the data representing questions from the question store 1108 and causes the display device 1104 to display the questions to the person. In some embodiments where the question store 1108 stores survey questions in different languages, the survey application 814 retrieves questions in a preferred language of the person from the question store 1108. The survey application 814 receives responses to the questions from the person through the input device 1100. When the survey application 814 receives the responses, the survey application 814 stores data representing the responses in the response store 1106 in a language-neutral format. In addition, the survey application 814 uses the network interface 1102 to send data representing the responses to the server computing system 804. In other embodiments, the survey application 814 stores data representing the responses in the preferred language of the person, but converts the data into another language prior to sending the data to the server computing system 804.

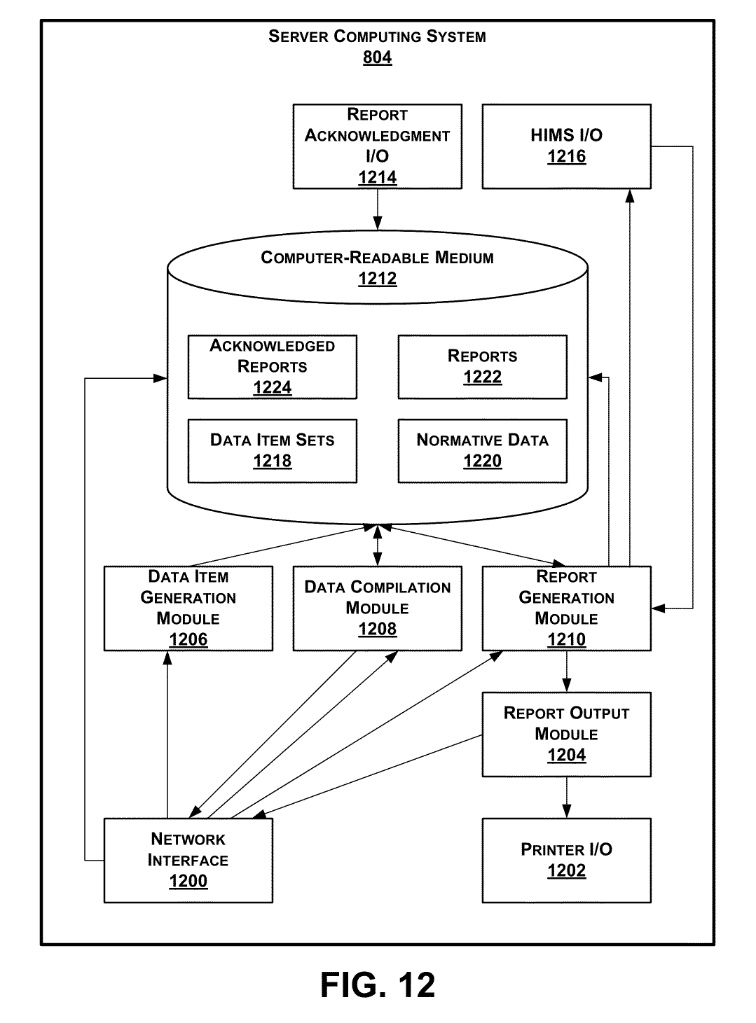

FIG. 12 is a schematic logical block diagram illustrating example details of the server computing system 804. In other embodiments, other server computing systems are implemented in different ways.

In the example of FIG. 12, the server computing system 804 comprises a network interface 1200, a printer I/O 1202, a report output module 1204, a data item generation module 1206, a data compilation module 1208, a report generation module 1210, a computer readable medium 1212, a report acknowledgment I/O 1214, and a HIMS I/O 1216. The computer-readable medium stores data item sets 1218, normative data 1220, graphical reports 1222, and acknowledged versions of reports 1224.

The network interface 1200 is implemented in different ways in different embodiments. For instance, in different embodiments, the network interface 1200 is implemented as one or more Ethernet cards, one or more fiber optic interfaces, one or more wireless cards, and/or one or more other types of network interface cards. Likewise, the printer I/O 1202 is implemented in different ways in different embodiments. For instance, the printer I/O 1202 is a parallel port, a universal serial bus (USB) port, or another type of port that facilitates communication with a printer. The report acknowledgment I/O 1214 is also implemented in different ways in different embodiments. For instance, the report acknowledgment I/O 1214 may be implemented as one or more Ethernet cards, one or more fiber optic interfaces, one or more wireless cards, one or more USB ports, one or more FireWire ports, and/or one or more other types of components capable of receiving acknowledged versions of graphical reports or acknowledgment data. Similarly, the HIMS I/O 1216 is implemented in different ways in different embodiments. For instance, the HIMS I/O 1216 may be implemented as one or more Ethernet cards, one or more fiber optic interfaces, one or more wireless cards, one or more USB ports, one or more FireWire ports, and/or one or more other types of components capable of receiving data from a HIMS.

The computer readable medium 1212 is implemented in different ways in different embodiments. For instance, in different embodiments, the computer readable medium 1212 comprises one or more random access memory (RAM) modules, one or more magnetic disk drives, one or more solid state memory drives, one or more optical discs, one or more Bernoulli cartridges, one or more Flash memory drives, and/or one or more other types of devices or articles of manufacture capable of storing data.

The report output module 1204, the data item generation module 1206, the data compilation module 1208, and the report generation module 1210 are implemented in different ways in different embodiments. For instance, in some embodiments, the report output module 1204, the data item generation module 1206, the data compilation module 1208 and/or the report generation module 1210 are implemented as sets of software instructions executed by a processing unit of the server computing system 804. In other embodiments, the report output module 1204, the data item generation module 1206, the data compilation module 1208 and/or the report generation module 1210 are implemented using one or more ASICs.

The network interface 1200 enables the server computing system 804 to communicate on a computer network. Moreover, the network interface 1200 receives input from a client device in data communication with the server computing system 804. For instance, the network interface 1200 receives data representing responses to questions in one or more surveys.

When the network interface 1200 receives data representing responses to questions in the one or more surveys, the data item generation module 1206 obtains a data item set corresponding to the responses. After the data item generation module 1206 obtains the data item set, the data item generation module 1206 stores the data item set in the computer readable medium 1212.

In different embodiments, the data item generation module 1206 obtains data items corresponding to the responses in different ways. For instance, in one example embodiment, the data item generation module 1206 sends the data representing the responses to a server operated by a third party. The server operated by the third party then sends a data item set corresponding to the responses back to the data item generation module 1206. In this example embodiment, where the survey is a survey in the SF series of surveys published by QualityMetric, Inc., the server operated by third party is operated by or on behalf of QualityMetric, Inc.

In additional example embodiments, the data item generation module 1206 calculates data items in the data item set. In different ones of these additional embodiments, the data item generation module 1206 calculates the data items in different ways. For instance, in one example embodiment, the data item generation module 1206 translates each of the responses into a numerical value. The data item generation module 1206 then performs one or more mathematical operations over one or more of the numerical values to generate a data item in the data item set. For instance, the data item generation module 1206 may add together the two of the numerical values to generate a data item in the data item set. Furthermore, in some instances, when the data item generation module 1206 performs the mathematical operations over the one or more numerical values, the data item generation module 1206 weights particular ones of the numerical values such that greater or less significance is applied to ones of the numerical values. In other embodiments, other mathematical operations are used, such as mean, median, maximum, minimum, division, addition, subtraction, mode, and/or other types of mathematical operations.

The report generation module 1210 uses the data item sets 1218 in the computer readable medium 1212 to generate graphical reports. The report generation module 1210 generates graphical reports like the graphical report 108 in the example of FIG. 3 and the graphical report 108 in the example of FIG. 1. This way, the server computing system 804 operates as the report generation engine 106 in the example of FIG. 1. When the report generation module 1210 generates a graphical report, the report generation module 1210 stores the graphical report in the computer readable medium 1212.

In some example embodiments, the report generation module 1210 uses the normative data 1220 when generating graphical reports. The normative data 1220 includes data indicating normative ranges for a perceived person characteristic. When the report generation module 1210 uses the normative data 1220 to generate a graphical report, the report generation module 1210 generates the graphical report such that at least one graph in the graphical report indicates a normative range for a perceived person characteristic corresponding to the graph.

Furthermore, in some example embodiments, the normative data 1220 includes data indicating typical progress of patients in response to one or more therapies. In such embodiments, when the report generation module 1210 uses the normative data 1220 to generate a graphical report, the report generation module 1210 generates the graphical report such that at least one graph in the graphical report comprises a trend line indicating typical progress of patients in response to a therapy.

In addition, in some example embodiments, the report generation module 1210 uses data obtained to through the HIMS I/O 1216 to generate graphical reports. For instance, the report generation module 1210 may use demographic data obtained through the HIMS I/O 1216 to generate the demographic data in the person background areas of graphical reports. Moreover, in some example embodiments, the report generation module 1210 uses data obtained through the HIMS I/O 1216 to generate one of more graphs in a graphical report that correspond to objective person characteristics. Furthermore, in some embodiments, when the report generation module 1210 generates a graphical report, the report generation module 1210 uses the HIMS I/O 1216 to instruct the HIMS to store data that links the graphical report to a patient's medical data stored at the HIMS.

The report output module 1204 directs graphical reports to the network interface 1200 or the printer I/O 1202, as appropriate. For instance, in different implementations, the report output module 1204 is configured to send data representing graphical reports to the network interface 1200 when a medical caregiver uses a computing device to review graphical reports and to send data representing graphical report to the printer I/O 1202 when a medical caregiver uses printed copies of graphical reports to review the graphical reports. The printer I/O 1202 enables the server computing system 804 to communicate with the printer 808.

The report acknowledgment I/O 1214 receives input indicating that a medical caregiver has reviewed a graphical report. In different embodiments, the report acknowledgment I/O 1214 receives different types of input indicating that the medical caregiver has reviewed a graphical report. For instance, in one example embodiment, the report acknowledgment I/O 1214 receives a digital image of a page upon which the graphical report is printed and upon which the medical caregiver has indicated that the medical caregiver has reviewed the graphical report. In other example embodiments, the report acknowledgment I/O 1214 receives digital signatures or electronic signatures associated with the graphical report.

When the report acknowledgment I/O 1214 receives input indicating that a medical caregiver has reviewed a graphical report, the report acknowledgment I/O 1214 stores an acknowledged version of the graphical report in the computer readable medium 1212. For instance, in some example embodiments, the report acknowledgment I/O 1214 generates acknowledgment data in response to receiving the input. The acknowledgment data indicates that a medical caregiver has reviewed the graphical report. The report acknowledgment I/O 1214 then stores an acknowledged version of the graphical report in the computer readable medium 1212. The acknowledged version of the graphical report includes the acknowledgment data.

The data compilation module 1208 generates aggregate graphical reports. Aggregate graphical reports are similar to the graphical reports discussed above. However, graphical indicators in the graphs of an aggregate graphical report correspond to data items that correspond to responses provided by multiple people. For instance, graphical indicators in a graph of an aggregate graphical report may correspond to data items that correspond to responses provided by each patient treated by a medical caregiver. In another instance, graphical indicators in a graph of an aggregate graphical report may correspond to data items that correspond to responses provided by each patient treated at a hospital. In one example embodiment, the data compilation module 1208 generates an aggregate graphical report by compiling data item sets from multiple persons over a given period of time to generate a plurality of aggregated data item sets. The data compilation module 1208 then generates the aggregate graphical report based on the plurality of aggregated data item sets.

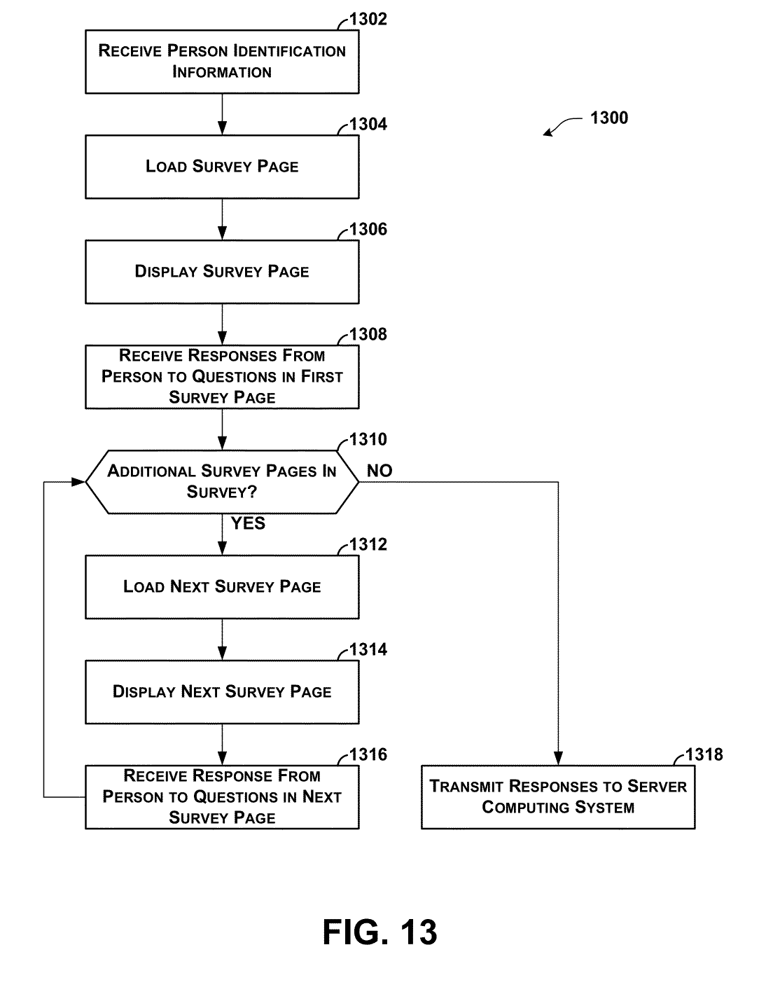

FIG. 13 is a schematic flow diagram illustrating an example operation 1300 of the client device 810. In different embodiments, the client device 810 performs different operations. Furthermore, in different embodiments, the client device 810 performs operations having more or fewer steps or having the steps in different orders.

As illustrated in the example of FIG. 13, the operation 1300 begins when the survey application 814 receives person identification information (1302). The person identification information identifies an individual person. For instance, the person identification information may be a username, a PIN number, a fingerprint, or another type of information that identifies a person.

After receiving the person identification information, the survey application 814 loads a first survey page from the question store 1108 (1304). Upon loading the survey page, the survey application 814 causes the display device 1104 to display the first survey page (1306). Subsequently, the survey application 814 receives, via the input device 1100, responses from the person to the questions in the first survey page (1308).

After the survey application 814 receives the responses, the survey application 814 determines whether there are any additional survey pages in the survey (1310). If there are additional survey pages in the survey (“YES” of 1310), the survey application 814 loads a next survey page in the survey from the question store 1108 (1312). The survey application 814 then causes the display device 1104 to display the next survey page (1314). Subsequently the survey application 814 receives, via the input device 1100, responses from the person to the questions in the next survey page (1316). The survey application 814 then loops back and again determines whether there are any additional survey pages in the survey (1310). If there are no additional survey pages in the survey (“NO” of 1310), the survey application 814 causes the network interface 1102 to send data representing the responses to questions in the survey to the server computing system 804 (1318).

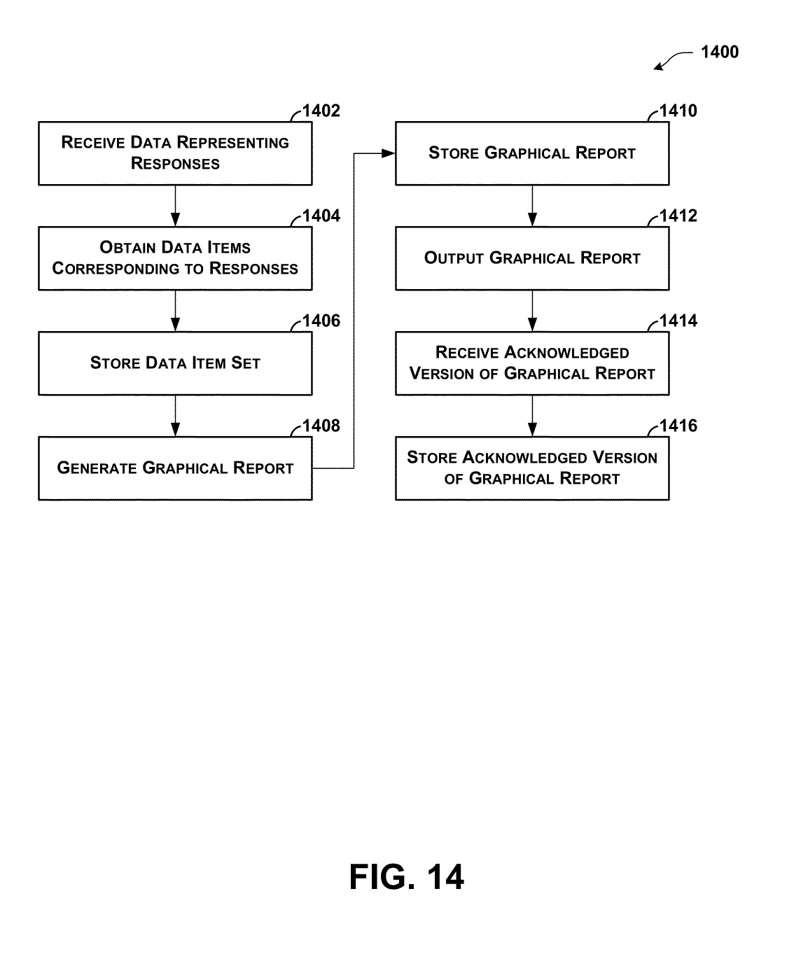

FIG. 14 is a schematic flow diagram illustrating an example operation 1400 of the server computing system 804. In different embodiments, the server computing system 804 performs different operations. Furthermore, in different embodiments, the server computing system 804 performs operations having more or fewer steps or having the steps in different orders.

As illustrated in the example of FIG. 14, the operation 1400 begins when the network interface 1200 receives data representing responses provided by the person to questions in one or more surveys (1402). After the network interface 1200 receives the data, the data item generation module 1206 obtains a data item set corresponding to the responses (1404). The data item generation module 1206 then stores the data item set in the computer readable medium 1212 (1406).

Subsequently, the report generation module 1210 uses the data item sets 1218 and the normative data 1220 in the computer readable medium 1212 to generate a graphical report (1408). In some instances, when the report generation module 1210 generates the graphical report, the report generation module 1210 uses data received from the HIMS I/O 1216. When the report generation module 1210 generates the graphical report, the report generation module 1210 stores the graphical report in the computer readable medium 1212 (1410).

Subsequently, the report output module 1204 outputs the graphical report (1412). As described above, in some embodiments, the report output module 1204 outputs the graphical report by sending data representing the graphical report to the printer I/O 1202 for printing. In other embodiments, the report output module 1204 outputs the graphical report by sending data representing the graphical report to the network interface 1200 for transmission to another computing device.

Later, the report acknowledgment I/O 1214 receives an acknowledged version of the graphical report (1414). When the report acknowledgment I/O 1214 receives the acknowledged version of the graphical report, the report acknowledgment I/O 1214 stores the acknowledged version of the graphical report in the computer readable medium 1212 (1416).

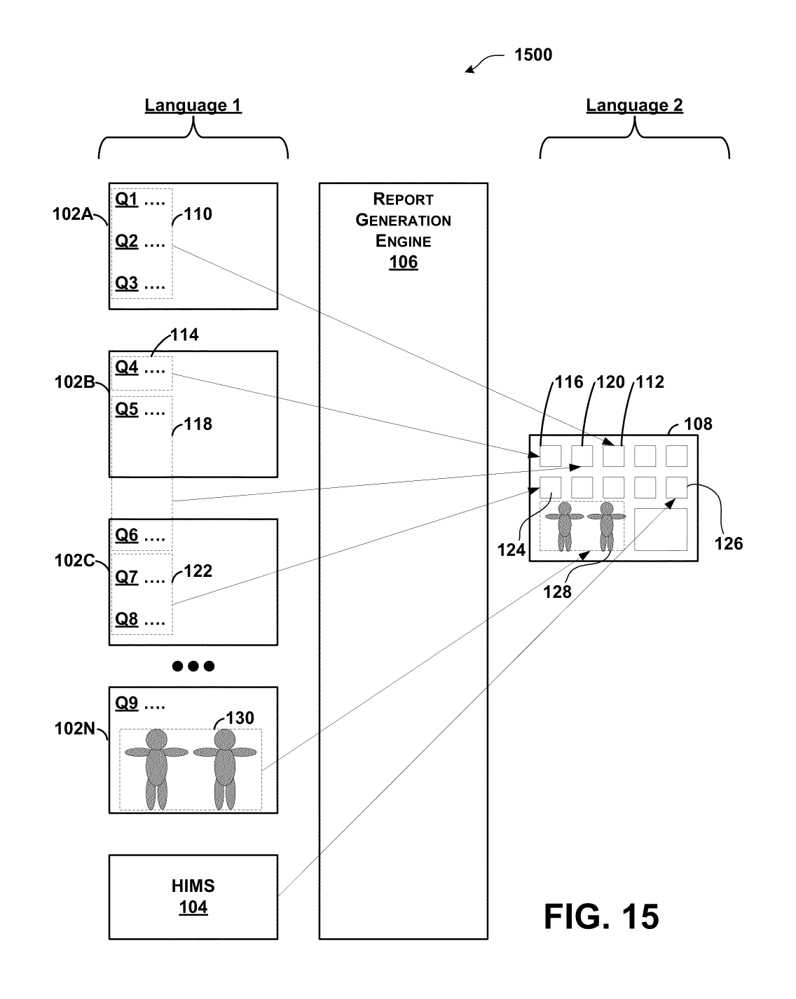

FIG. 15 is a schematic diagram illustrating an example system 1500 for generating a graphical report from person reported data where questions are presented in a one language and a graphical report is presented in another language. Other embodiments generate a graphical report from person reported data where questions are presented in a first language and a graphical report is presented in a second language in different ways.

The system 1500 includes each of the same components as the system 100 illustrated in the example of FIG. 1. In the example of FIG. 15, the questions in the survey pages 102 are presented in one language and the graphical report 108 is presented in another language. In the example of FIG. 15 shows that each question in the survey pages 102 is presented in Language 1. Furthermore, the example of FIG. 15 shows that text in the graphical report 108 is presented in language 2. Language 1 and language 2 are different languages. For instance, language 1 may be French and language 2 may be Portuguese. Many other language combinations are possible. It should be appreciated that in other embodiments, the types of reports other than graphical report 108 are generated based on responses to questions in one language where the reports are presented in another language.

In some embodiments, when the client device sends data representing the responses to the report generation engine 106, the data representing the responses is language-neutral. For instance, the data representing the responses may be expressed as numbers assigned to variables, name-value pairs, data identifiers, or other types of language-neutral data. In other embodiments, the client device and/or the report generation engine 106 perform one or more operations to translate the responses.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A method for generating a person outcome report presenting information corresponding to perceived person characteristics as perceived by a person, the method comprising:
storing a plurality of data item sets on a computer readable medium, the plurality of data item sets including at least first and second data item sets, the first data item set comprising at least one data item, and the second data item set comprising at least another data item; and
generating a graphical report on a single page, the act of generating being executed by at least one programmable circuit, the graphical report presenting a plurality of graphs, at least one of the graphs presenting at least first and second graphical indicators, the first graphical indicator corresponding to the first data item set, the second graphical indicator corresponding to the second data item set, the one data item in the first data item set and the another data item in the second data item set corresponding to the same perceived person characteristic as perceived by the person at different times.

2. The method of claim 1, wherein the single page is a single piece of paper.

3. The method of claim 1, wherein the single page is a single page on a user interface, the user interface displayed on an electronic device.

4. The method of claim 1, wherein generating the graphical report comprises: displaying the graphical report on a display device.

5. The method of claim 1, wherein each graph in the plurality of graphs comprises at least a magnitude axis.

6. The method of claim 5, wherein each graph in the plurality of graphs further comprises a time axis.

7. The method of claim 1, wherein the plurality of graphs in the graphical report is subdivided into at least a first category and a second category, each graph in the first category containing data items corresponding to perceived person characteristics related to general health of the person, each graph in the second category containing data items corresponding to perceived person characteristics related to a medical specialty.

8. The method of claim 1, wherein generating the graphical report comprises: generating the graphical report such that the graphical report comprises a graphical representation of at least a portion of a human body, the graphical representation of at least the portion of the human body showing at least one location where the person perceives a symptom to have occurred on the body of the person.

9. The method of claim 8, wherein the portion of the human body is a body part.

10. The method of claim 8 further comprising:
displaying, by a client device, a graphical representation of at least the portion of the human body;
receiving, by the client device, input from the person indicating where the person perceives the symptom to have occurred.

11. The method of claim 1 further comprising: storing an acknowledged version of the graphical report, the acknowledged version of the graphical report comprising acknowledgment data, the acknowledgment data indicating that a medical caregiver has reviewed the graphical report.

12. The method of claim 11 further comprising:
receiving input indicating that the medical caregiver has reviewed the graphical report; and
generating the acknowledgment data in response to receiving the input.

13. The method of claim 11, wherein the acknowledgment data is selected from the group comprising: a digital signature and an electronic signature.

14. The method of claim 11, wherein the acknowledged version of the graphical report is a digital image of a page upon which the graphical report is printed and upon which the medical caregiver has indicated that the medical caregiver has reviewed the graphical report.

15. The method of claim 1 further comprising: ascertaining at least one code denoting medical services provided.

16. The method of claim 15, the code comprising an Evaluation/Management (E/M) code.

17. The method of claim 15, the code comprising a Current Procedural Terminology (CPT) code.

18. The method of claim 1, wherein generating the graphical report comprises generating the graphical report such that the at least one graph comprises a graphical indicator indicating a normative range for the perceived person characteristic corresponding to the at least one graph.

19. The method of claim 1, wherein generating the graphical report comprises generating the graphical report such that at least one graph in the plurality of graphs comprises a trend line indicating typical progress of patients in response to a therapy.

20. The method of claim 1, further comprising:
receiving, at a server device, input from a client device in data communication with the server device; and
calculating the first data item set based on the input.

21. The method of claim 20, the client device belonging to a type of computing device selected from the group comprising: a tablet computer, a desktop computer, a netbook computer, a laptop computer, a kiosk, a personal digital assistant, and a smart phone.

22. The method of claim 20,
wherein the method further comprises:
receiving, by the client device, responses from input by the person, the responses being responsive to questions in a survey; and
sending, by the client device, data representing the responses to the server device; and
wherein receiving the input from the client device comprises: receiving, by the server device, data representing the responses.

23. The method of claim 22,
wherein the method further comprises: displaying, by the client device, the questions in the survey in a first language; and
wherein generating the graphical report comprises: generating the graphical report such that the graphical report is in a second language, wherein the first language and the second language are different.

24. The method of claim 22,
wherein the client device operates a web browser application;
wherein the method further comprises:
sending, by the web browser application, a request to the server device;
receiving, by the web browser application, data representing the questions in the survey; and
sending, by the web browser application, data representing the responses to the server device.

25. The method of claim 22,
wherein the server device operates a web server application;
wherein the method further comprises:
receiving, by the web server application, a request;
sending, by the web server application, the questions in the survey to the client device; and
receiving, by the web server application, the responses from the client device.

26. The method of claim 1,
wherein generating the graphical report comprises: generating the graphical report at a server computing system; and
wherein the server computing system is located at a location selected from the group comprising: a location local to a medical caregiver and a location remote from the medical caregiver.

27. The method of claim 1, wherein storing the plurality of data item sets comprises: storing the plurality of data item sets at a location selected from the group comprising: a computing device local to the person, a computing device local to a medical caregiver, and a computing device remote from the person and the medical caregiver.

28. The method of claim 1, wherein the person is selected from the group comprising: a patient receiving medical care and a research subject.

29. The method of claim 1, wherein the perceived person characteristic is an aspect of pain perceived by the person.

30. The method of claim 29, wherein the aspect of pain perceived by the person is selected from the group comprising: physical pain, weakness, and numbness.

31. The method of claim 1,
wherein generating the graphical report comprises generating the graphical report such that at least one of the graphs in the graphical report presents at least a third graphical indicator and a fourth graphical indicator, the third graphical indicator corresponding to a third data item set, the fourth graphical indicator corresponding to a fourth data item set, a data item in the third data item set and a data item in the fourth data item set corresponding to another person characteristic of the person at different times the perceived person characteristic; and
wherein the other person characteristic is selected from the group comprising: mental state and quality of health.

32. The method of claim 1, wherein generating the graphical report comprises: generating the graphical report such that the graphical report further comprises comorbidity data and demographic data.

33. The method of claim 1, wherein generating the graphical report comprises generating the graphical report such that at least one of the graphs in the graphical report presents at least a third graphical indicator and a fourth graphical indicator, the third graphical indicator corresponding to a third data item set, the fourth graphical indicator corresponding to a fourth data item set, a data item in the third data item set and a data item in the fourth data item set corresponding to the same objective person characteristic of the person at different times.

34. The method of claim 33 further comprising retrieving the third data item set and the fourth data item set from a hospital information management system.

35. The method of claim 1 further comprising:
compiling data item sets from multiple persons over a given period of time to generate a plurality of aggregated data item sets; and
generating an aggregate graphical report based on the plurality of aggregated data item sets.

36. The method of claim 1, wherein the first data item set corresponds to a first outpatient encounter for treatment of a medical condition and the second data item set corresponds to a subsequent outpatient encounter for treatment of the medical condition.

37. The method of claim 1 further comprising:
displaying the graphical report on a display device;
receiving input indicating a graphical indicator in a graph in the plurality of graphs; and
in response to receiving the input indicating the graphical indicator, displaying on the display device survey questions and responses corresponding to the graphical indicator.

38. A computing system comprising:
a computer readable medium storing:
a plurality of data item sets, the plurality of data item sets including at least first and second data item sets, the first data item set comprising at least one data item, and the second data item set comprising at least another data item; and
software instructions; and
a programmable circuit, the software instructions, when executed by the programmable circuit, cause the computing system to generate a graphical report on a single page, the graphical report presenting a plurality of graphs, at least one of the graphs presenting at least first and second graphical indicators, the first graphical indicator corresponding to the first data item set, the second graphical indicator corresponding to the second data item set, the one data item in the first data item set and the another data item in the second data item set corresponding to the same perceived person characteristic as perceived by the person at different times.

39. A method for generating a person outcome report presenting information corresponding to perceived person characteristics as perceived by a person, the method comprising:
receiving a plurality of responses from a client device, each response in the plurality of responses being responsive to a question in a survey;
storing a plurality of data item sets on a computer readable medium, the plurality of data item sets including at least first, second, third, fourth, fifth, and sixth data item sets, the first data item set comprising at least one data item, the second data item set comprising at least one data item, the third data item set comprising at least one data item, the fourth data item set comprising at least one data item, the fifth data item set comprising at least one data item, and the sixth data item set comprising at least one data item;
generating a graphical report on a single page, the act of generating being executed by at least one programmable circuit, the graphical report presenting a plurality of graphs,
at least a first graph in the plurality of graphs presenting at least first and second graphical indicators, the first graphical indicator corresponding to the first data item set, the second graphical indicator corresponding to the second data item set, a data item in the first data item set and a data item in the second data item set corresponding to pain as perceived by the person at different times, the first graph further presenting a normative range for pain,
at least a second graph in the plurality of graphs presenting at least third and fourth graphical indicators, the third graphical indicator corresponding to the third data item set, the fourth graphical indicator corresponding to the fourth data item set, a data item in the third data item set and a data item in the fourth data item set corresponding to weakness as perceived by the person at different times, the second graph further presenting a normative range for weakness,
at least a third graph in the plurality of graphs presenting at least fifth and sixth graphical indicators, the fifth graphical indicator corresponding to the fifth data item set, the sixth graphical indicator corresponding to the sixth data item set, a data item in the fifth data item set and a data item in the sixth data item set corresponding to numbness as perceived by the person at different times, the third graph further presenting a normative range for numbness,
the graphical report further presenting an illustration of a human body, the illustration of the human body presenting at least one graphical indicator indicative of where on the person's body the person has perceived a symptom, and
the graphical report further presenting textual data.
